(19) United States
(12) Patent Application Publication
(10) Pub. No.: US 2013/0254085 A1
(43) Pub. Date: Sep. 26, 2013

(54) Online Produce Brokerage

(71) Applicants: Christopher Downey Tanimoto, Venice, CA (US); Darrell Thomas Benvenuto, Venice, CA (US)

(72) Inventors: Christopher Downey Tanimoto, Venice, CA (US); Darrell Thomas Benvenuto, Venice, CA (US)

(21) Appl. No.: 13/426,594

(22) Filed: Mar. 21, 2012

(51) Int. Cl. G06Q 40/04

(52) U.S. Cl. 705/37

(57) ABSTRACT

Disclosed are computer systems for facilitating market transactions between sellers, buyers, and carriers of perishable commodities. One system includes computer hardware that: features computer readable memory containing program code; and is organized according to client-server architecture. In the same embodiment, the hardware plus associated program code and architecture are configured for: sellers to list the prices and quantities of perishable commodities; buyers to search or bid for listed commodities by price; buyers to order listed commodities for delivery; a seller's approval of orders; buyers or sellers to list haul orders based on approved orders, wherein the haul orders identify a pickup and delivery location plus the ordered quantities of commodities; carriers to search for and provide a price quote for serviceable haul orders; buyers or sellers to approve quoted prices for a haul orders; and, buyers, sellers, or carriers to negotiate payments for approved commodities or haul orders.

### BACKGROUND OF THE INVENTION

1. Field of the Invention

One or more embodiments setting forth the ideas described throughout this disclosure pertain to the field of computer systems for online produce brokerage. More particularly, but not by way of limitation, one or more aspects of the disclosure enable produce brokerage computer systems for sellers, buyers, and carriers of crops and other produce.

2. Description of the Related Art

Perishable agricultural commodities (including crops and other produce) are a class of foodstuff consumed by people throughout the United States and internationally. In modern societies, most perishable agricultural commodities are remotely grown with respect to the location where said commodities are consumed. Two practical consequences arise as a result: first, originators (“Sellers”) and consumers or resellers (“Buyers”) of the commodities must seek each other out to negotiate the price and exchange of the commodities; and, second, either the originators (“Sellers”) or consumers or resellers (“Buyers”) of the commodity must make transport arrangements for the commodity.

Many different approaches have been applied by buyers and sellers for seeking one another out to negotiate the price and exchange of commodities. Sometimes, sellers employ sales teams to contact buyers to inform them of an available commodity. Other times, buyers contact sellers to identify whether the seller has a particular commodity that the buyer needs. Yet still, other times, buyers and sellers provide information to brokers who attempt to make buyer-seller matches for the exchange of commodities. These approaches have not been entirely satisfactory because: (1) the administrative costs and burdens associated with identifying potential buyers and sellers are high; (2) it can be impractical to contact all buyers and sellers of a particular commodity so that the most ideal buyer-seller match may be missed or overlooked; (3) too much time spent identifying a buyer or seller can result in the spoilage of the commodity; and, (4) in emergency situations, buyers can randomly need commodities on short-term notice so that finding an ideally matched seller becomes unimportant whereby the most ideal buyer-seller match may be missed or overlooked. As a result, a need exists for mechanisms which allow buyers, sellers, and brokers to quickly and constantly identify ideal buyer-seller matches without high administrative costs or burdens.

Many different approaches have been applied by buyers, sellers, and brokers of perishable commodities for arranging freight transport services for the commodities. In some instances, sellers or buyers have their own delivery vehicles, but such vehicles may not be suited for the bulk delivery or the long-distance transport of perishable goods. As a result, many buyers and sellers are confined to local buyer-seller matches and non-bulk orders, even though a more remote buyer-seller match or bulk order would have been better for both the buyer and seller. In other instances, buyers, sellers, and brokers arrange to have the goods transported by third-party carriers (“carriers”). However, third-party carriers are most practical for bulk commodity orders so that buyers and sellers of non-bulk orders cannot fully benefit from the third party carriers. Also, using third party carriers renders tracking of in-transit commodities orders by a buyer or seller difficult, if not impossible. Accordingly, a need exists for mechanisms which allow buyers, sellers, and brokers to (a) quickly identify and coordinate ideal transport arrangements for perishable commodities and (b) track the commodities as they are being transported.

### BRIEF SUMMARY OF THE INVENTION

At a high level the disclosure set forth herein is directed toward computer systems for brokerage of perishable commodities and freight services, including but not limited to online brokerage of commodities and freight services. More particularly, one or more aspects of the disclosure may be to enable computer systems for facilitating market transactions between sellers, buyers, and carriers of perishable commodities. In one embodiment, the system is defined by computer hardware that: (A) features computer readable memory containing program code; and (B) is organized according to a client-server architecture. In the same embodiment, the hardware plus associated program code and architecture are configured for: (1) sellers to list prices and quantities of perishable commodities; (2) buyers to search for quantities of perishable commodities by a variety of search criteria, including, but not limited to, price, name, grade, type, seller, shipping distance, and etcetera; (3) buyers to order or bid on quantities of commodities for delivery; (4) a seller's approval of orders by buyers; (5) buyers or sellers to list haul orders based on approved orders of buyers, wherein the haul orders identify a pickup and delivery location plus the ordered quantities of perishable commodities; (6) carriers to search for and provide price quotes for serviceable haul orders; (7) buyers or sellers to approve quoted prices for haul orders; and, (8) buyers, sellers, or carriers to provide brokerage fee payments for employing the computer system.

### BRIEF DESCRIPTION OF THE DRAWINGS

The above and other aspects, features and advantages of the ideas conveyed through this disclosure will be more apparent from the following more particular description thereof, presented in conjunction with the following drawings wherein:

FIG. 1 illustrates an exemplary hardware architecture diagram of the system.

FIGS. 2A and 2B are a flow chart illustrating generally some basic logic of system operations.

FIG. 3 is provided for purposes of illustrating the functionalities of the system defined by computer implemented program code.

FIG. 4 is a breakdown of the 1.1 “account creation” sub-functionality of the 1 “account creation” high level functionality.

FIG. 5 is a breakdown of the 1.2 “maintenance of account specifications” sub-functionality, which functionality encompasses any operations involving existing account details.

FIG. 6 is a breakdown of the 1.3 “account activity tracking” sub-functionality.

FIG. 7 is a breakdown of the 2.1 “creation of commodity listing” sub-functionality of the 2 “management of inventory” high level functionality.

FIG. 8 is a breakdown of the 2.2 “maintenance of listing specifications” sub-functionality of the system.

FIG. 9 is a breakdown of the 2.3 “listing search engine” sub-functionality of the system.

FIG. 10 is a breakdown of the 3.1 “auction creation” sub-functionality of the 3. “management of auctions” high level functionality.

FIG. 11 is a breakdown of the 3.2 “auction direction sub-functionality” of the system.

FIG. 12 is a breakdown of the 3.3 “maintenance of auction specifications” sub-functionality.

FIG. 13 is a breakdown of the 4.1 “order placement” sub-functionality within the 4. “management of orders” high level functionality.

FIG. 14 is a breakdown of the 4.2 “order direction” sub-functionality of the system.

FIG. 15 is a breakdown of the 5.1 “transaction processing” sub-functionality.

FIG. 16 is a database model which represents a preferable database management structure for the disclosed system.

FIG. 17 is a sequence chart showing request fulfillment between the Presentation, Business Logic, and Data Tiers of the disclosed system.

FIGS. 18 and 19 are examples of private cloud data center locations.

FIG. 20 is a schematic of a Single iSCSI Private Cloud SAN Configuration.

FIG. 21 is a schematic of a High-Availability, Redundant Data Path iSCSI Private Cloud SAN Configuration.

FIG. 22 is a flow chart of the logic underlying a Dispute Resolution System.

FIG. 23 is a flow chart of a Live Order Tracking System.

FIG. 24 is a diagram of a server configuration that may be employed by the disclosed system.

### DETAILED DESCRIPTION

Disclosed are computer systems for facilitating market transactions between sellers, buyers, and carriers of perishable commodities. In one embodiment, the system is defined by computer hardware that: (A) features computer readable memory containing program code; and (B) is organized according to a client-server architecture. First, we describe the general characteristic of the computer hardware plus its associated program code and architecture. Next, we describe the systems functionality of facilitating market transactions between sellers, buyers, and carriers of perishable commodities. In the following exemplary description numerous specific details are set forth to provide a more thorough understanding of the ideas described throughout this specification. It will be apparent, however, to an artisan of ordinary skill that embodiments of ideas described herein may be practiced without incorporating all aspects of the specific details described herein. In other instances, specific aspects well known to those of ordinary skill in the art have not been described in detail so as not to obscure the disclosure. Readers should note that although examples of the innovative concepts are set forth throughout this disclosure, the claims, and the full scope of any equivalents, are what define the invention.

A. Computer Hardware Plus its Associated Program Code and Architecture

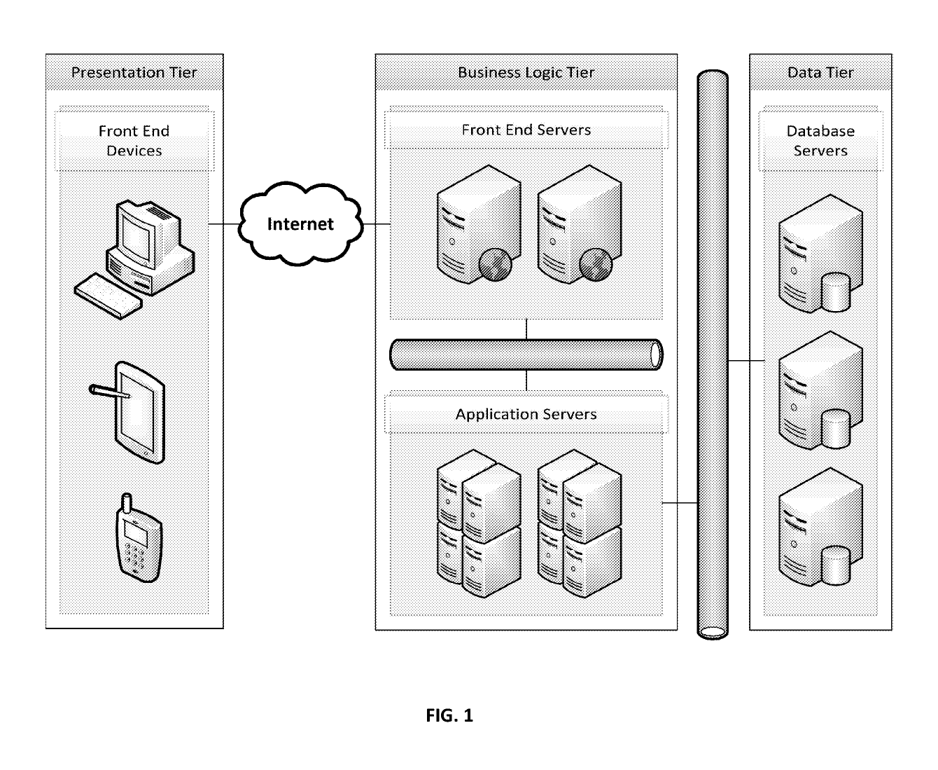

FIG. 1 illustrates a hardware architecture diagram of the system. As shown, the architecture is a three-tier client-server architecture that is organized according to the Model-View-Controller (“MVC”) paradigm into a presentation tier 100, a business logic tier 200, and a data tier 300. The presentation tier 100 may preferably be a front end device having computer hardware with computer readable memory containing program code. The business logic tier 200 may be comprised of front end and/or application servers with computer readable memory containing program code. The data tier 300 may suitably be defined by at least one database server having computer readable memory.

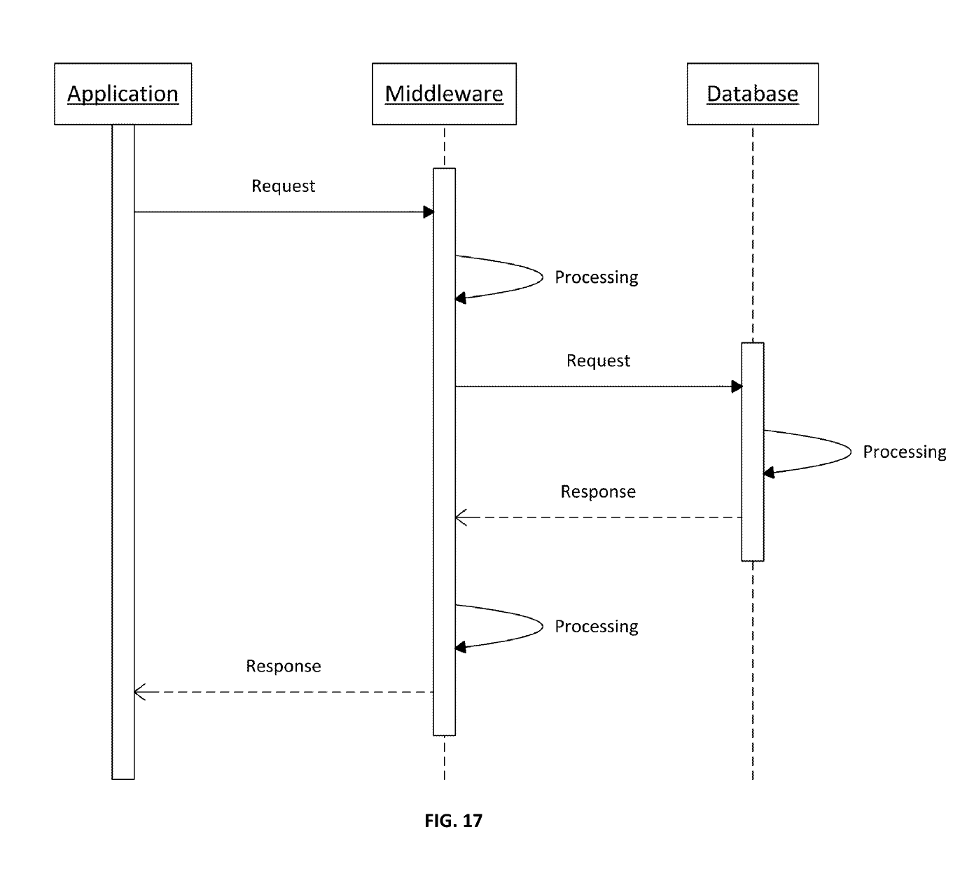

Still referring to FIG. 1, a purpose of the presentation tier 100 may suitably be to provide an interface for a user to view and perform operations on data stored in the data tier 300 via services rendered by the business logic tier 200. The presentation tier 100 may preferably be a front end device having computer hardware with computer readable memory containing program code. The computer hardware of the presentation tier 100 should preferably be configured for user interaction and communication with the business logic tier 200 (typically via connection to the internet or over a cellular or other wireless data network). In many instances, the computer hardware with computer readable memory may be a front end device such as a personal computer, a laptop computer, a tablet computer, a portable digital assistant (PDA), a cellular phone, a media player, or the like. The program code of the presentation tier should preferably be configured with at least two layers, namely, (a) a human or user interface layer and (b) a service query layer. The service query layer of the program code may preferably be configured to communicate with the business logic tier 200. The human or user interface layer of the program code may suitably be configured to (i) receive commands from a user for operating the service query layer and (ii) present data communicated to the service query layer from the business logic tier 200 to a user. FIG. 17 represents a sequence chart of the above described system.

Referring yet again to FIG. 1, a purpose of the business logic tier 200 is to populate and query the computer memory of the database server(s) of the data tier 300 and to communicate query results to the presentation tier 100. The business logic tier 200 may be comprised of front end and/or application servers with computer readable memory containing program code. The front end and application servers of the data tier 200 should preferably be configured for communication with the presentation tier 100. A Network Interface Card (NIC) is an example of the type of computer hardware component that may provide the configuration necessary for communication with the presentation tier 100. Suitably, communication may be accomplished over Local Area Network (LAN), Wide Area Network (WAN), Wireless network, optical network, distributed network, telecommunications network or any combination thereof with the internet. The program code of the business logic tier 200 should preferably be configured with three modules, namely, a first module configured to populate the computer memory of the database tier 300, a second module configured to query the computer memory of the database tier 300, and a third module configured for communication with the presentation tier 100. The more specific details of the program code of the business logic tier 200 is suitably disclosed in greater detail below.

Further referring to FIG. 1, a purpose of the data tier 300 is to store data provided to it by the business logic tier 200. The data tier 300 may suitably be defined by at least one database server having computer readable memory. Numerous types of data storage devices may serve as the computer readable memory of the data tier. For example, magnetic, optical or magnetic-optical storage systems, or any other available mass storage technology that provides a repository for digital information may be used.

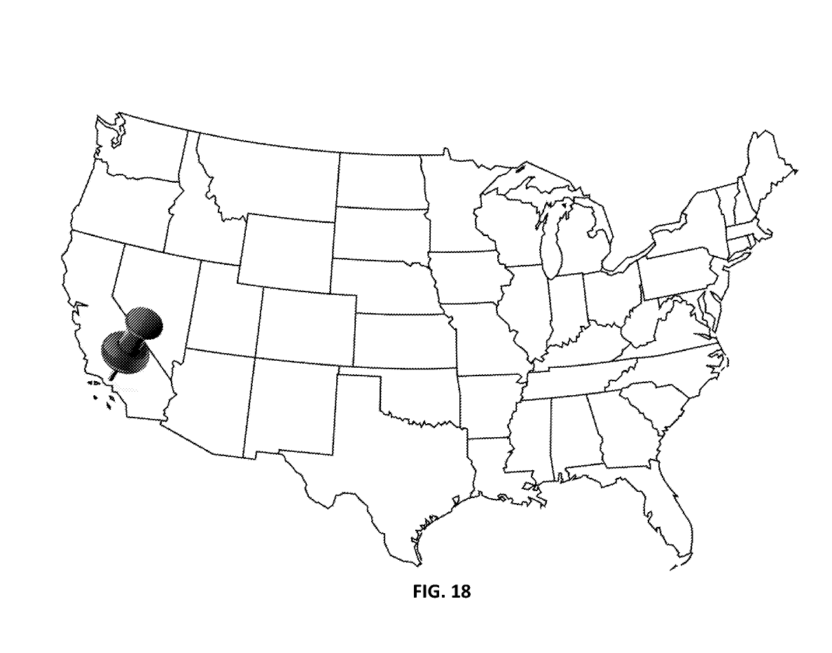

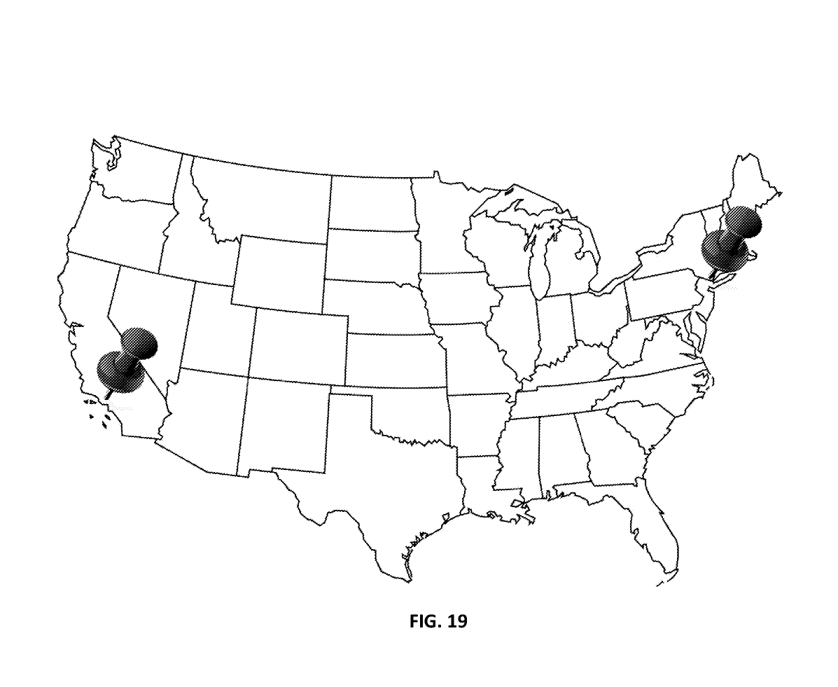

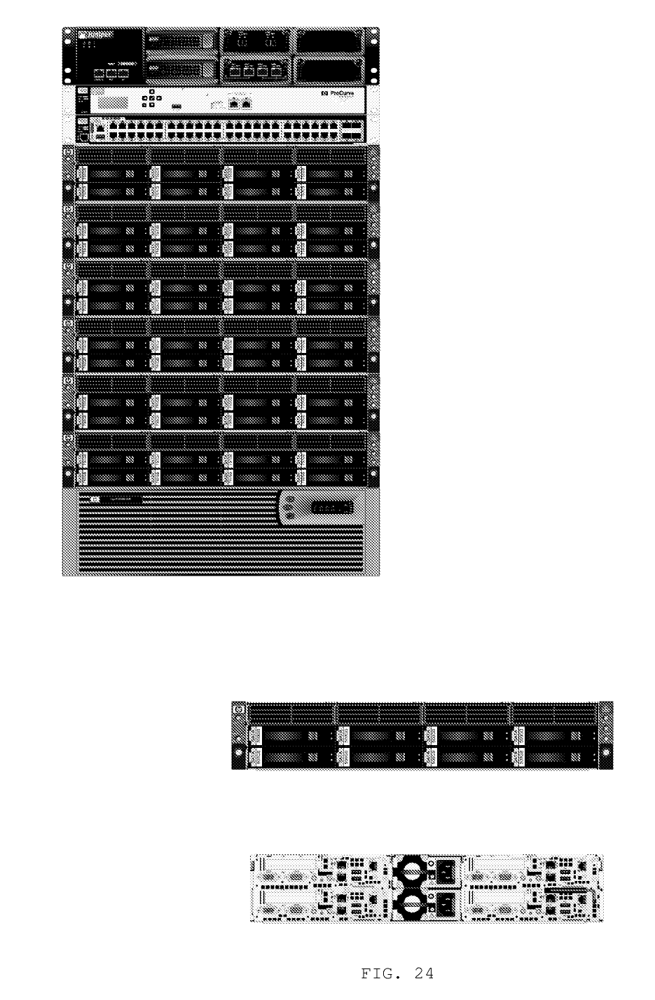

All of the servers shown in FIG. 1 may suitably be either physical or virtual (e.g., existing within a private cloud). In one embodiment, there will be a single cluster of servers provided at a location known as a datacenter (see, e.g., FIG. 18) defining a private cloud instance. In one embodiment, multiple clusters may be provided at various locations known as datacenters (see, e.g., FIG. 19) to help ensure continuous uptime. In a preferred embodiment, the cluster of servers of a private cloud will be as follows: a 10 Gbps (gigabits per second) Stateful Packet Firewall (e.g., Juniper IDP 8200); a Network Management Module; a 48-port 10 Gbps (gigabits per second) Enterprise Switch; six 4 Node Servers (e.g., HP Proliant DL 2000 Multi-Node Servers); and a 5 KVA (kilovolt-ampere) UPS (uninterruptible power supply). See, e.g., FIG. 24.

In one embodiment, the 10 Gbps (gigabits per second) Stateful Packet Firewall is a Juniper IDP 8200 (“the Juniper”). Suitably, for the private cloud the Juniper IDP 8200 provides intrusion protection, network honeypots, Distributed Denial of Service (DDoS) blocking and seven-layer stateful packet inspection for all traffic coming into the cloud. Preferably, the Juniper may be capable of inspecting and handling up to 10 Gbps (gigabits per second) of throughput without congestion.

The Network Management Module may be defined by a ProCurve DCM (Datacenter Connection Manager) Controller and the 48-port 10 Gbps (gigabits per second) Enterprise Switch may be defined by an HP ProCurve 6600-48G-4XG Switch (“4XG Switch”). Preferably, the Juniper feeds directly into one of the four 10 Gbps (gigabits per second) ports of the 4XG Switch, which may be managed by the DCM Controller.

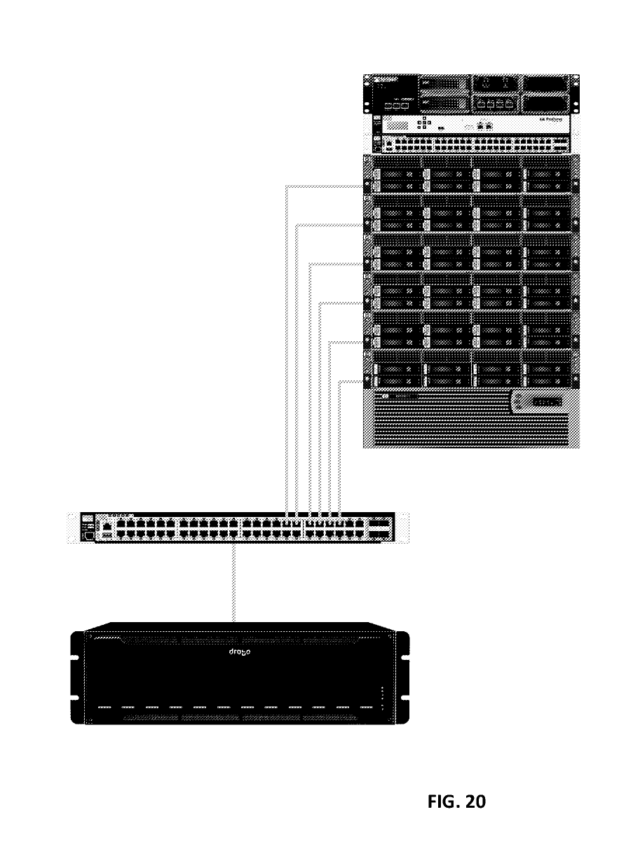

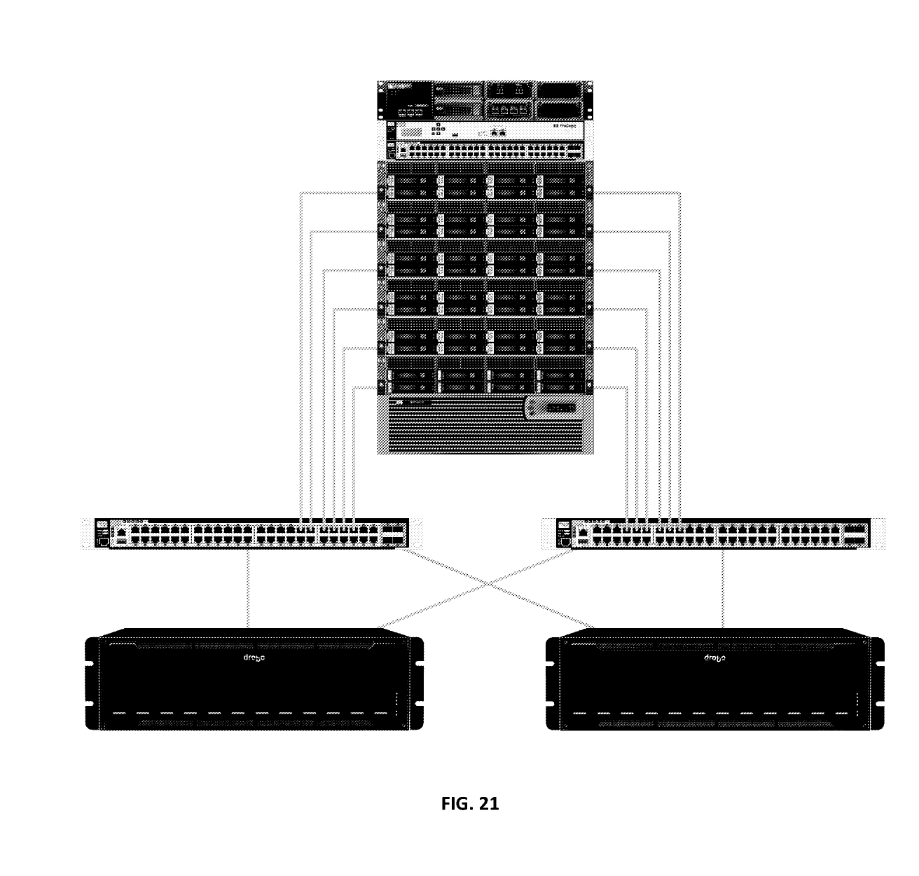

The six 4 Node Servers may each be defined by an Hewlett-Packard (HP) Proliant DL 2000 Multi-Node Server. Suitably, the DCM Controller helps handle traffic shaping, server provisioning and traffic redirection across the physical nodes in the cloud. Suitably, all of the nodes in the cluster below the 4xG Switch (up to 24 nodes) receive two 1 Gbps ports on the switch, allowing for a maximum of 48 (with 24 nodes). Typically, outbound data packets from each node are load-balanced across the two ports. In an alternate embodiment of the system, each node may be configured with an additional add-on network interface card, the port of which can be dedicated to handling Internet Small Computer System Interface (iSCSI) data traffic in order to transfer data to and from a rack-mounted shared storage device (which storage device may suitably be a Data Robotics DROBO B1200i or similar Storage Area Network (SAN) rack-mounted shared storage device, through a second dedicated twenty four port 1 Gbps (gigabit per second) Enterprise class network Switch (e.g., an HP ProCurve E6600-24G-4XG Switch or equivalent)) (see, e.g., FIG. 20). In an alternate embodiment of the system, the additional add-on network interface card may provide two ports, wherein two shared storage devices and switches may be attached in the manner shown in FIG. 21 which provides redundant connections to both shared storage devices and may prevent the failure of any single component (port, switch, one storage device) from creating a loss of access to the data stored redundantly upon the two shared storage devices. The number of nodes in each cloud may not be fixed, but may instead be initially established with a number of nodes suitable to handle initial user load along with a margin for growth, then subsequently expanded whenever necessary to properly service expanding user load. In some instances, each HP Proliant DL 2000 Multi-Node Server may be configured with from one to four (1-4) nodes, each node containing two (2) Intel Xeon X5675 Series 3.06 GHz six-core central processing units (CPUs), a 1 GB (gigabyte) Cache Memory Smart Array P410 8 Port Serial Attached SCSI (SAS) RAID Storage Controller with Flash-Backed Write Cache (FBWC), an HP Smart Array Advanced Pack (SAAP) and 192 GB (gigabytes) of Double Data Rate Three (DDR3) 800 Registered Dual In-line Memory Modules (RDIMMs).

B. Overview of the System

As alluded to above, one or more aspects of the disclosure is to enable computer systems for facilitating market transactions between sellers, buyers, and carriers of perishable commodities. The system may suitably be configured for three types of users: buyer accounts, seller accounts, and carrier accounts. All of the accounts have various permissions for accessing and operating the system.

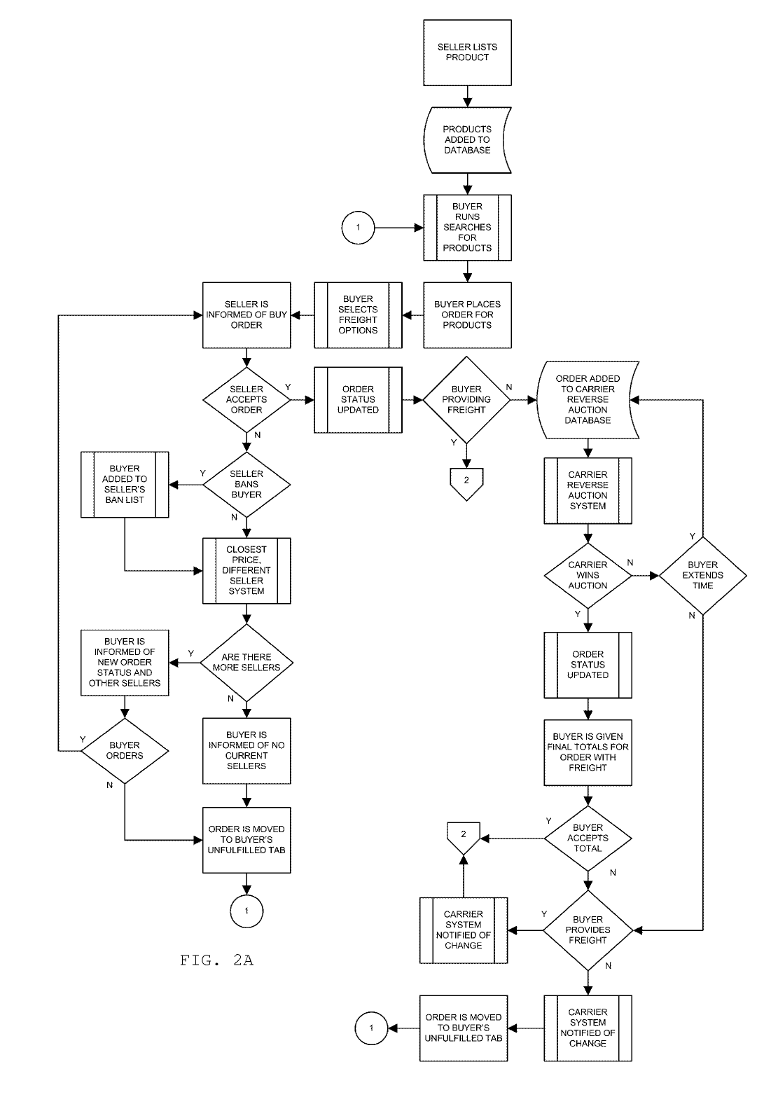

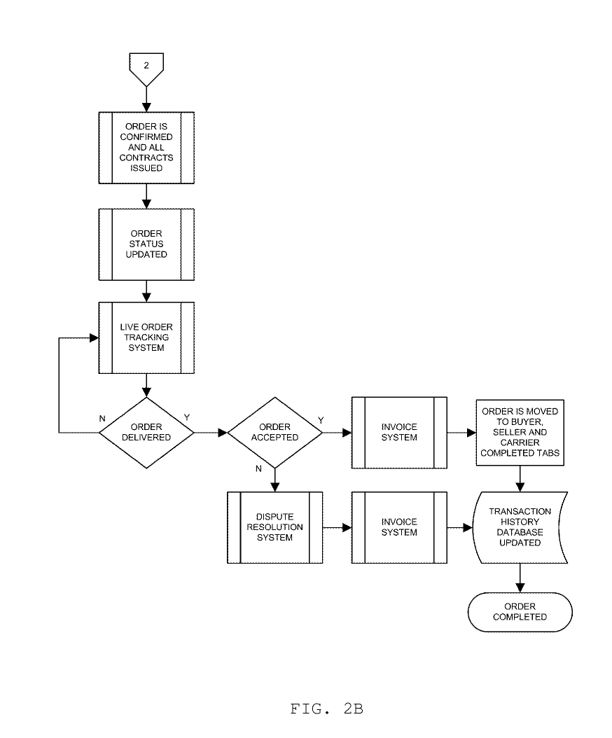

FIG. 2 is a flow chart illustrating generally some of the logic of system operations. First, a plurality of seller accounts may be used to populate a database with commodity listings. A buyer account may be used to query the database for commodity listings and, whenever a suitable listing is discovered, the buyer may request to purchase the listed commodities from the seller account responsible for the listing. Suitably, the seller account responsible for the listing may be informed of the purchase request and provided with the option for accepting the order from the buyer. If the seller accepts the purchase order, then the order status is updated and the listing is provided to a reverse auction database wherein carrier accounts may bid to provide freight services for the order. If the seller does not accept the purchase order, then buyer is automatically provided with commodity listings of other seller accounts and the seller is presented with the option of banning the buyer, an act which creates a seller-removable block, the presence of which prevents that seller's commodity listings from appearing in that buyer's search results. If another commodity listing is available, then the buyer may make additional purchase requests and repeat the process again with another seller account, else the buyer is informed that no commodity listings are available. Preferably, the buyer may save the search query so that the system may notify the buyer as soon as a matching commodity listing is made available.

Still referring to FIG. 2, once an order has been accepted by the seller, the listing is populated to a reverse auction database wherein carrier accounts bid to provide freight services for the orders. Suitably, the carrier account providing the lowest bid will be deemed the auction winner. If no bids are made, then the buyer may choose to extend the auction time or the listing may be provided to a database of orders in need of freight service. Sellers may choose to provide the freight services in lieu of the carrier's services by matching or beating the winning bid. Similarly, a buyer may choose to separately arrange for the freight services of another carrier or provide their own freight services in lieu of either accepting the winning bid or extending the auction time when no bids are made.

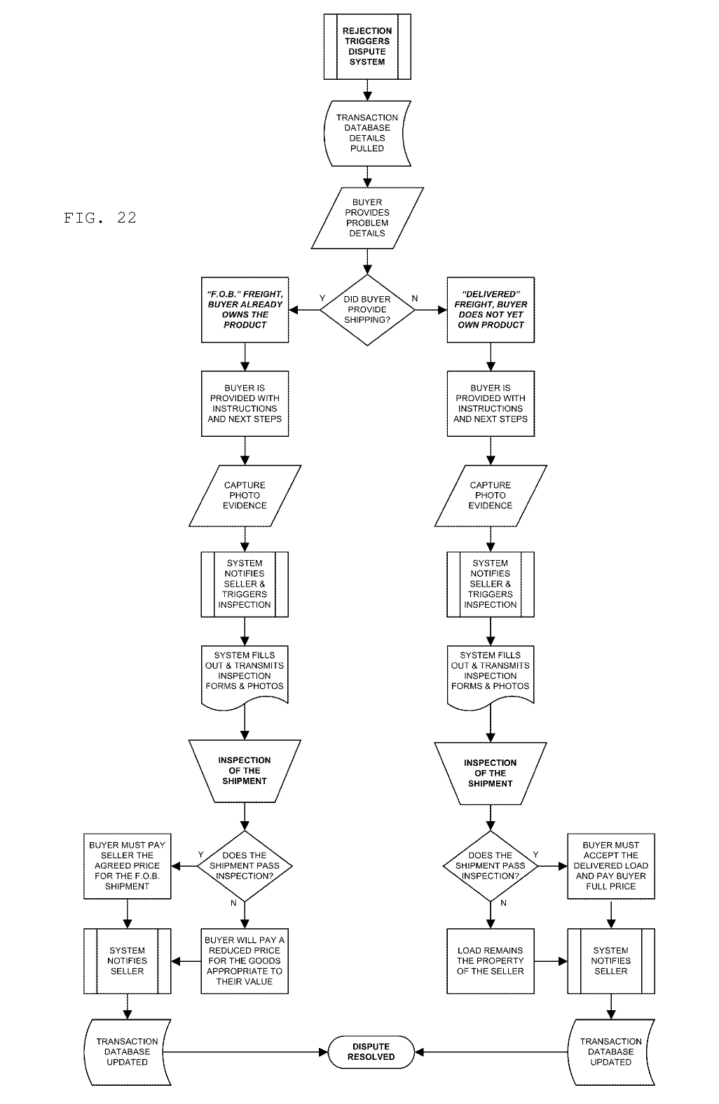

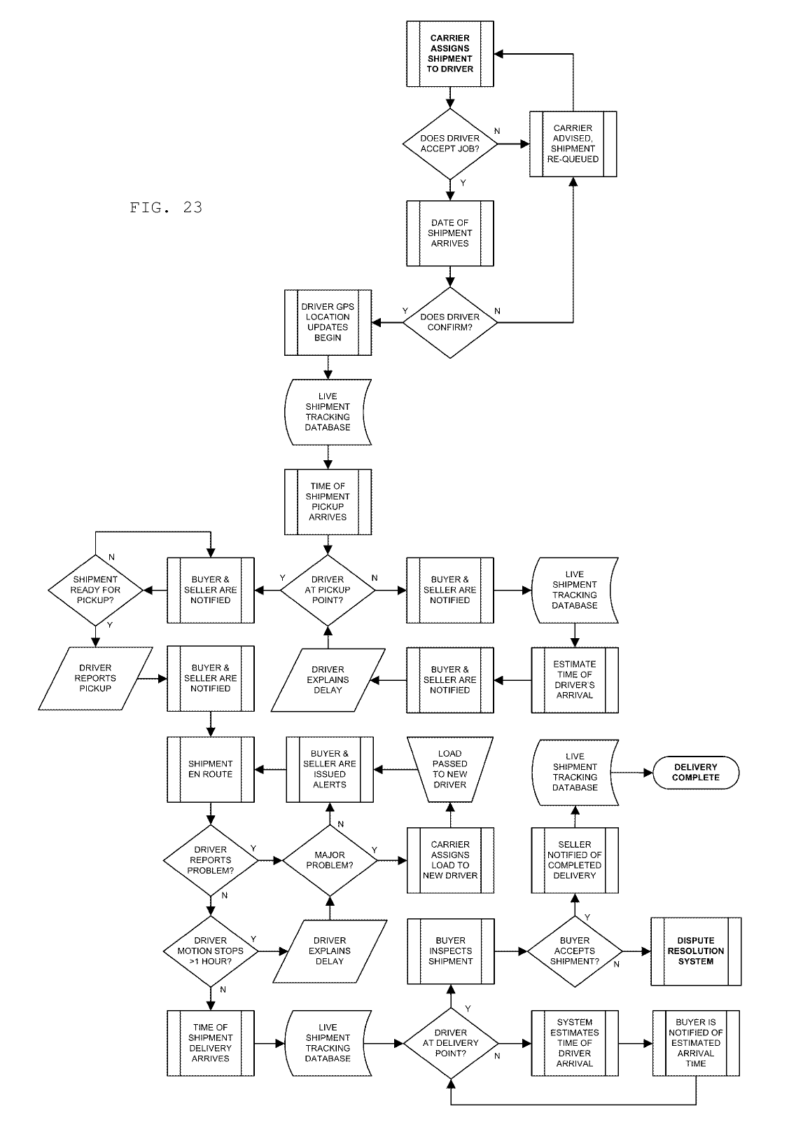

Continuing the flow of FIG. 2, Buyers are provided with a review of the commodity and shipping service order for final approval. The buyer has the option of approving the overall transaction, replacing the assigned shipping service with their own freight service, or canceling the order. If the order is cancelled, then the order is deemed unfilled, else the order is confirmed and provided to the Live Order Tracking System (see FIG. 23) for tracking the shipment of the underlying commodity. When the commodity has been delivered to the buyer, the buyer will inspect the delivered product. At this point, the buyer has the option of accepting the order or rejecting it. If the order is accepted, the order is deemed completed. If the order is rejected, then the order may preferably be transferred to the Dispute Resolution System (see FIG. 22). Within said Dispute Resolution System, the rejecting buyer provides details as to the reasons behind their rejection, via a user interface on their presentation-tier device. The buyer may also suitably have the opportunity to provide photographic evidence to support their rejection, e.g., whenever their presentation-tier device is equipped with a camera (e.g., Smart Phone, Tablet, etc). The system may then suitably prepare a full report and initiate an independent inspection (e.g., a USDA inspection) of the delivered commodity to determine whether the commodity meets the standards expressed in the contract between the parties. Whenever the independent inspection is initiated, IF the inspector determines that the shipped commodity did in fact meet the conditions for “good delivery” of the commodity, THEN: (a) the buyer is required to accept the commodity (whenever freight delivery was provided through the system) and the order is deemed completed, ELSE the commodity remains the property of the seller; or (b) the buyer assumes ownership of the commodities at full price at pick-up from the seller (whenever freight delivery services were provided by the buyer (called “Free On Board” (FOB) Freight)), ELSE the seller is required to negotiate a lower price for the commodity to accommodate the lower value of the product.

In view of the foregoing, the disclosed system generally provides the following functionalities: (1) commodity listing (e.g., the ability of sellers to list prices and quantities of perishable commodities for sale); (2) commodity search (e.g., the ability of buyers to search for quantities of perishable commodities listed in the commodity listing); (3) order placement (e.g., the ability of buyers to order quantities of commodities from the commodity listing); (4) order approval (e.g., the ability of sellers to approve of orders by buyers); (5) freight listing (e.g., the ability of buyers or sellers to list haul orders based on an approved orders of buyers, wherein the haul orders identify a pickup and delivery location plus the ordered quantities of perishable commodities); (6) freight auction search (e.g., the ability of carriers to search for and provide a price quote for serviceable haul orders in the freight listing); (7) reverse freight auction (e.g., the ability of buyers or sellers select a carrier from the quoted prices for a haul order in the reverse freight auction); (8) order confirmation; and, (9) payment collection (e.g., the ability of buyers, sellers, or carriers to provide payments for approved commodities, haul orders, fees, or other expenses).

(1) Commodity Grade

In one aspect of the disclosed system, sellers populate the data tier 300 (referring back to FIG. 1) with a commodity listing. A commodity listing is a data set representing information that is necessary for buyers to take decisive action. For instance, a commodity listing may include: seller name; seller location; listing title; listing price; listing duration (the length of time that a listing will be made available); listing quantity; commodity information; commodity photograph; commodity origin; commodity grade; lot size (for freight calculations); lot weight (for freight calculations); payment terms (e.g., acceptable payment methods); any customized comments or descriptions.

A commodity listing may be provided to the system as follows. Referring still to FIG. 1, sellers first enter the data set composing the commodity listing via text entry into a front end device of the presentation tier 100. Thus, the front end device should be configured with a visual output display and include program code for a graphical user interface (GUI) with prompts for the various datum in the commodity listing. Suitably, the program code may be configured in the form of a step-by-step wizard which collects the commodity listing via text entry or preset options for the various datum in the commodity listing (e.g., commodity information and commodity photograph be subject to common descriptions and images). Suitably, sellers may determine a market value by requesting recent sale prices of similar commodities in the system for review from the business logic tier 200. Sellers may either (a) set a fixed price for the commodity or (b) set a “relative” price that is automatically adjusted by the system to maintain its position relative to the changing average selling price of similar commodities in the system. Upon entry of the commodity listing into the front end device, a preview of the listing may suitably be presented to the seller via the GUI with an option for editing the various datum within the listing. After the commodity listing is finalized the seller may communicate the commodity listing to the business logic tier 200 with a command that the listing be populated to the database server of the data tier 300. Once in the data tier 300, the business logic tier 200 may query the data tier 300 regarding the commodity listing and deliver the commodity listing to the GUI of the seller's front end device of the presentation tier 100 for editing. Once a commodity listing has been saved within the data tier 300, the listing may be configured for use at a later time as a template wherein sellers may modify the template to prepare a commodity listing for similar commodities without redundant input of commodity information.

(2) Commodity Search

Referring still to FIG. 1, it is contemplated that the data tier 300 may be populated with a plurality of commodity listings as described above. Buyers may employ the system to search through the commodity listings for particular commodity listings which match the needs of the buyers.

A commodity search may be accomplished as follows. Referring once again to FIG. 1, a buyer preferably may input a search string via text entry or via a series of selections within a graphic user interface (GUI) into a front end device of the presentation tier 100. In a preferred embodiment, the front end device may suitably be configured with a visual output display and include program code for a GUI and search engine with a search string prompt. In an alternate embodiment, such functionality (e.g., the GUI and Search Engine) may suitably reside within the business logic tier 200 and the front end device of the presentation tier 100 may be suitably configured with a visual output display that will convey the content generated by the business logic tier 200 to the user and vice-versa. It is contemplated that the search engine features a variety of filters based on practical and relevant commodity listing data (e.g., seller location, listing price, and etcetera). After the search string is finalized the buyer may communicate the string to the business logic tier 200 with a command that the database server of the data tier 300 be queried with the search string. Suitably, one or more datum of each responsive commodity listing (e.g., listing title, seller name, or listing price) in the data tier 300 may be communicated by the business logic tier to the front end device of the presentation Tier 100 and presented in list format on its GUI. The search engine may suitably be configured to refine the search results according to the search filters identified above. It should be noted that: instead of a search string, the search query may be in the form of a command button which represents a predefined search (e.g., a predefined search for a particular commodity). Similarly, in one embodiment, individual buyer accounts may also predefine or otherwise associate search criteria with their respective buyer accounts, wherein any new commodity listings which match the search criteria may be automatically communicated to the client (e.g. via email, SMS messaging, fax, directly to their front end device, or the like).

Preferably, the search engine may further be configured to allow buyers to make “standing buy orders” rather than merely search through the commodity listings of seller accounts. A “standing buy order” is a buyer-created, seller searchable listing that is visible to sellers and wherein: (1) a buyer preferably identifies a desired commodity of a particular grade and an associated price at which the buyer is willing to purchase the commodity; and, (b) sellers may search through standing buy orders to locate entries which the sellers are willing to fulfill.

(3) Order Placement

Still referring to FIG. 1, buyers may employ the system to purchase particular quantities of a commodity. Suitably, a buyer may select a commodity listing from the search results and the listing may be associated with the buyer. Preferably, a priority lock is placed on the listing so that other buyers cannot make an order for the same listing or to place orders of a size that would exceed the remaining quantities in the listing after the portion the first buyer has elected to purchase has been locked (e.g., when the first buyer purchases 7 units out of a commodity listing of 10 units, the 7 units are locked and only 3 units remain available for purchase by a second buyer). Exhausted commodity listings are removed or suitably withheld from the search results. After the lock has been initiated, the order placement process begins wherein the buyer provides delivery and payment information to the system. It should be noted that, whenever an order is cancelled, the priority lock on the underlying commodity listing may preferably be removed and the quantity of commodity that has been removed from the listing due to the lock may suitably be made available for searching and ordering by a buyer.

In one embodiment, commodity listings feature a price for the commodity. It is contemplated that the buyer may request or otherwise negotiate a price reduction from the seller. The seller has the option of accepting or declining the buyer's new price. A buyer may make an order based on the negotiated price.

(4) Order Approval & (5) Freight Listing

After a buyer places an order through the system, the seller must approve of the order. Accordingly, order approval may suitably occur in three phases: (1) approval by the seller; (2) freight arrangements and approval by the carrier; and, (3) final approval by the buyer.

Approval by the Seller.

Upon an order request from a buyer, the system may deliver a notification to the seller with a review of the order plus a prompt for accepting the order terms. If the buyer has its own freight handling services, then the buyer may choose to associate its freight services with the order. Otherwise, if the buyer has not chosen to associate its freight services with the order, then the order is listed for carriers to bid for satisfaction of the freight services. In certain circumstances a seller may choose to decline an order, at which point the buyer is notified of the decision, the order status is changed to declined, and the buyer is preferably provided by the business tier 200 with an automatically generated selection of other alternative commodity listings which match the original search criteria of the buyer as closely as possible (e.g., in terms of commodity type, grade, price, and delivery distance). A seller further has the option of blocking all further orders from a particular buyer, wherein said seller's commodity listings are no longer presented to said particular buyer, even in circumstances where said buyer has a search query that potentially matches said seller's commodity listings. Blocked buyers may be unblocked by a seller at the option of the seller.

Freight Arrangements and Approval by the Carrier.

Whenever an order is approved and neither the seller nor the buyer provide freight services for an order, then the order may preferably be placed in the system for reverse auction to determine (a) the carrier responsible for performing the freight services and (b) the best prices for freight services. In certain instances, buyers or sellers may, through the system, specifically request a carrier or invite a carrier to bid on their freight needs. Upon completion of the reverse auction to determine costs for freight services, a seller may have the option of bidding a lower price than the carrier and providing the freight transport services. Similarly, upon completion of a reverse auction and upon receiving the final bid for freight costs through the system, a buyer may choose its own freight services in lieu of the reverse auction winner. Seller provided freight service is, for purposes of this specification, referred to as “Delivered” freight. Relatedly, “Free on Board” freight refers to, for purposes of this specification, freight services provided by the buyer instead of accepting the seller or system-provided freight, this is termed “Free On Board” (FOB) freight. Ultimately, the buyer and seller negotiate through the system to approve of the Freight transportation details.

Final Approval by the Buyer.

After transportation details are agreed to by the buyer and seller, the buyer is notified by the system. The total costs and freight handling services are suitably made available for review to the buyer. Either the buyer accepts the order to initiate the confirmation process or the buyer declines the order. If the buyer declines the order, then the seller and carrier are notified of the cancellation and any prior lock on the underlying commodities is lifted. Incomplete and cancelled orders may be stored in the system for review by the buyer, seller, or carrier involved in the order.

(6) Freight Auction Search

Purchase requests approved by a seller may suitably be provided to a reverse auction database wherein carriers may query the database to see the freight needs of the buyer/seller. The search for needed freight services may suitably be undertaken in a similar manner to searches of the commodity listings. Carriers may query the database for orders and bid to provide the services. Suitably, a search string may be provided in some instances for querying the orders. In other instances, the orders may be filtered according to datum in the listing (e.g., the delivery distance or the density, fragility, delivery price per mile, and other qualities of the commodity).

(7) Reverse Freight Auction

Carriers may suitably search through the reverse auction database for freight service needs of a buyer's purchase order. Suitably the auction is timed and the carriers bid the price for the freighting services down until the time runs out and the auction is over. The lowest bidding carrier is deemed the auction winner. Suitably, a proxy bidding system may be employed so that carriers do not have to monitor the auction. Preferably, two carriers with the same bid at the end of the auction result in a winner between the two being selected randomly. After the auction ends, the buyer is informed of the winning carrier. If the auction ends without any carrier bids, the buyer may be notified and provided with an option to relist the purchase order in the reverse auction database, perform the freight services by themselves, or cancel the order.

(8) Order Confirmation

Suitably, a buyer may approve of the carrier. The system may be configured to generate order confirmations in the form of industry standard contracts of sale and haul. The generated documents may suitably be electronically sent to the participating buyer, seller, and carrier.

(9) Payment Collection

A carrier suitably employs the system to update the order status and confirm that delivery of the commodity is completed. Invoices may be generated and electronically sent to the seller or buyer to collect fees associated with the transaction. The status of the order may be changed to reflect the awaited payment. Suitably, the transaction cycle ends after payment is received.

The system may further be used in other circumstances, namely: commodity auctions; contract listings; and, ad orders.

A commodity auction occurs whenever a seller owns (a) an out-of-season commodity or a commodity of small supply but high demand, (b) a load that has been rejected by a buyer upon delivery and is now available for purchase by other buyers, or (c) other commodity without a known true market value. In such circumstances, sellers do not want to sell the commodity for too low of a price. Accordingly, the system enables the seller to prepare a commodity listing as an auction instead of the ordinary listing outlined above. Interested buyers may bid on the commodity whereby sellers may obtain the best market price for the listings. The auction may preferably be relatively short (i.e. a couple of hours) since the seller is likely looking to dispose of the commodity in short order, but the seller has the option of extending the bidding period from only hours up to several days in length. In one embodiment, the standard order process continues when the auction ends.

In an alternate embodiment of the system, a unique or rare commodity listing (i.e., a listing without any currently active similar listings in the database) may suitably be automatically identified by the system so that the seller may be notified and informed of the option to place the listing as an auction, and possibly secure a higher price.

Contract listings are commodity purchase orders made between buyers and sellers in advance of the delivery date of the commodity. Contract listings are similar to commodity listings except buyers post the contract listings containing information about a commodity that is needed by the buyer at a later date. For example, the listing could be for several shipments of a specific commodity that is needed by a buyer six months from the listing date. Preferably, sellers may select orders to be filled based on the contract listing. In one embodiment, the price agreed upon is locked in for the duration of the contract listing regardless of market fluctuations. Freight transport services with similarly locked in rates may be arranged at the time of the order via the system. In an alternate embodiment of the system, carriers are eligible for a surcharge on shipping costs if the cost of fuel increases by more than a set percentage before the time of delivery.

Ad orders are similar to contract listings in that a buyer may list a commodity which they are willing to purchase at a future date. The purpose behind the listing is so that buyers can reserve the commodity for the listing price and advertise the commodity prior to actual receipt of the commodity. Like contract listings within the disclosed system, sellers may bid for the ad order in a reverse auction format. Freight transport services may be arranged at the time of the order.

It should be noted that freight transport services with prearranged rates can be selected at the time of the contract or ad order. Such an arrangement is preferable so that the final price to the buyer does not fluctuate. Also, a possibility exists wherein if such transport services are not prearranged, then there may be no transport services available at the time the buyer needs delivery of the commodity (e.g., during peak-time freight service demand, such as a holiday season).

C. Software

The software of the computer system will now be described. In the following exemplary description numerous specific details are set forth to provide a more thorough understanding of the ideas described throughout this specification. It will be apparent, however, to an artisan of ordinary skill that embodiments of ideas described herein may be practiced without incorporating all aspects of the specific details described herein. In other instances, specific aspects well known to those of ordinary skill in the art have not been described in detail so as not to obscure the disclosure. Readers should note that although examples of the innovative concepts are set forth throughout this disclosure, the claims, and the full scope of any equivalents, are what define the invention.

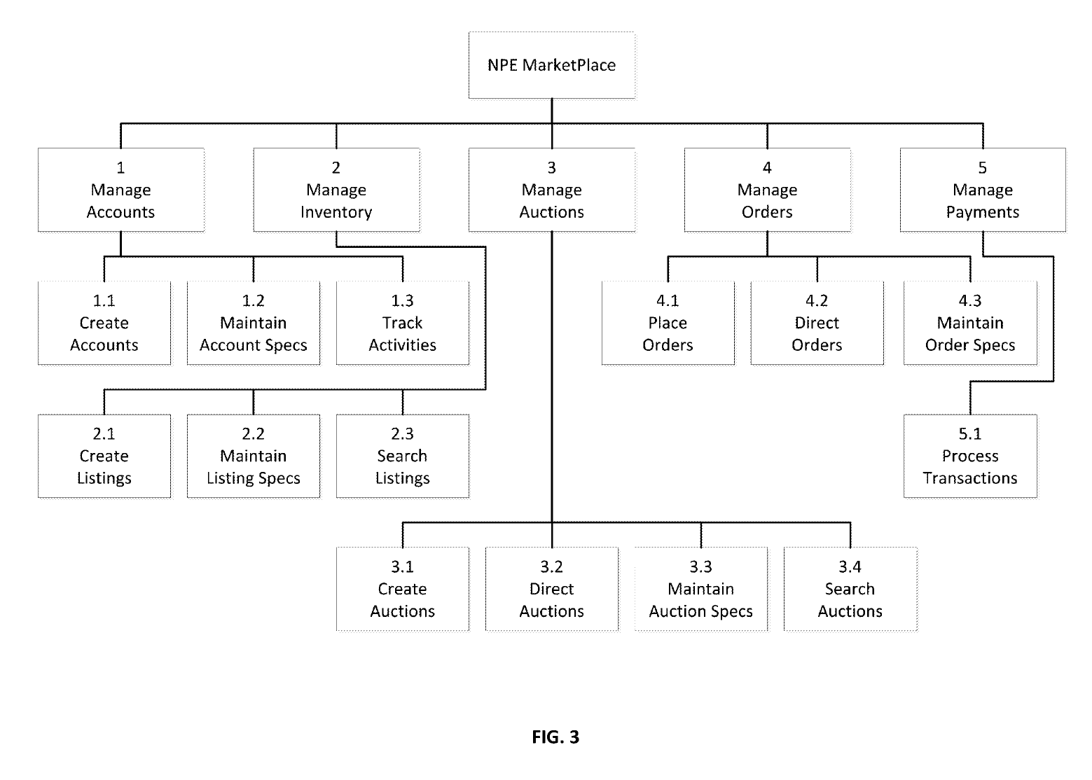

FIG. 3 is provided for purposes of illustrating the functionalities of the system defined by computer implemented program code. As shown in the figure, the software may be divided into five high level functionalities: 1. management of accounts; 2. management of inventory; 3. management of auctions; 4. management of orders; and 5. management of payments. Referring again to FIG. 1, these functionalities are (a) implemented with program code that executes on the front end device of the presentation tier 100 or program code on the servers of the business logic tier 200 of the system and (b) associated with databases in the data tier 300. For purposes of this disclosure, program code on the front end device is referred to as application software and program code on the servers is referred to as middleware. Each high level functionality may further be divided into sub functionalities.

1. management of accounts

1.1 account creation

1.2 maintenance of account specifications

1.3 account activity tracking

2. management of inventory

2.1 creation of commodity listing

2.2 maintenance of listing specifications

2.3 Listing search engine

3. management of auctions

3.1 auction creation

3.2 auction direction

3.3 maintenance of auction specifications

3.4 Auction search engine

4. management of orders

4.1 order placement

4.2 order direction

4.3 maintenance of order specifications

5. management of payment

5.1 transaction processing

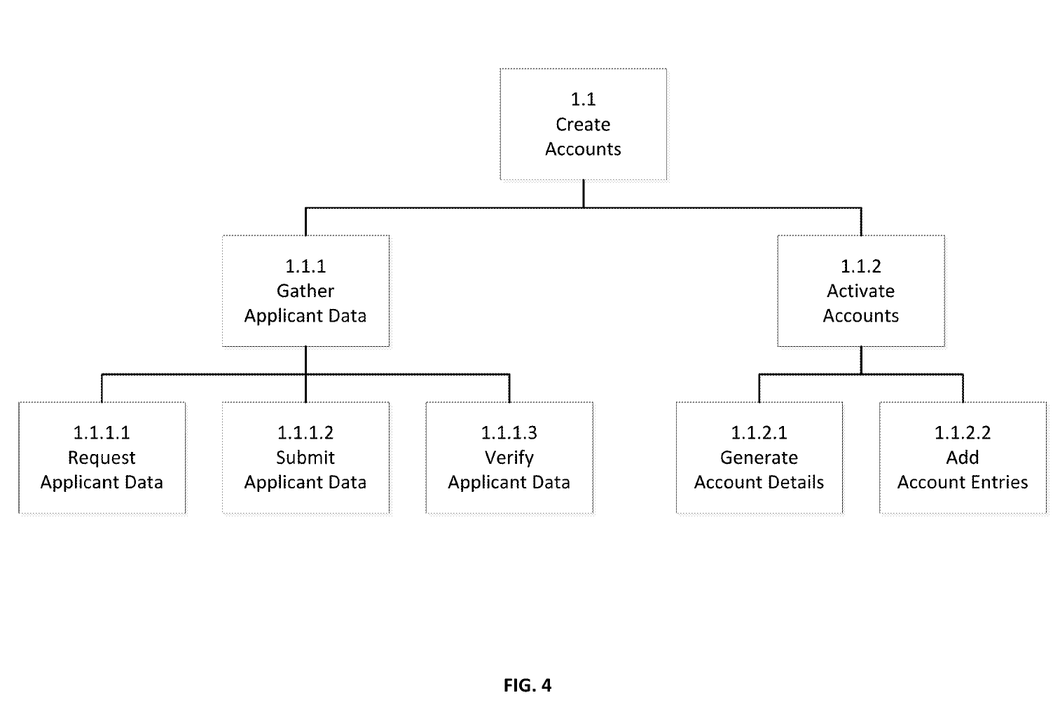

FIG. 4 is a breakdown of the 1.1 “account creation” sub-functionality of the 1 “account management” high level functionality. Suitably, the sub-functionality is configured to collect data relevant to a seller, buyer, or carrier of a commodity, populate the database of the data tier 300 with the data and associate the data with an account user name and password. Data may be provided to the databases in the form of tables. In one embodiment, data is requested from an account applicant through a GUI and provided to the middleware for population of the data tier 300 via the internet. Suitably, if the system identifies an error with the data (e.g., username collision or incorrect dates), the account cannot be created until the data is verified as valid (as defined by the system). After data validation, the middleware may suitably generate supplemental data for creating a new entry in the account tables of the database. After account generation, relevant data regarding the account is returned to the account applicant for reference or accounting purposes.

In one embodiment, the system contemplates three accounts: a buyer account, a seller account, and a carrier account. Brokers can use either buyer or seller accounts. Each account has its own permissions for operating the various functionalities of the system.

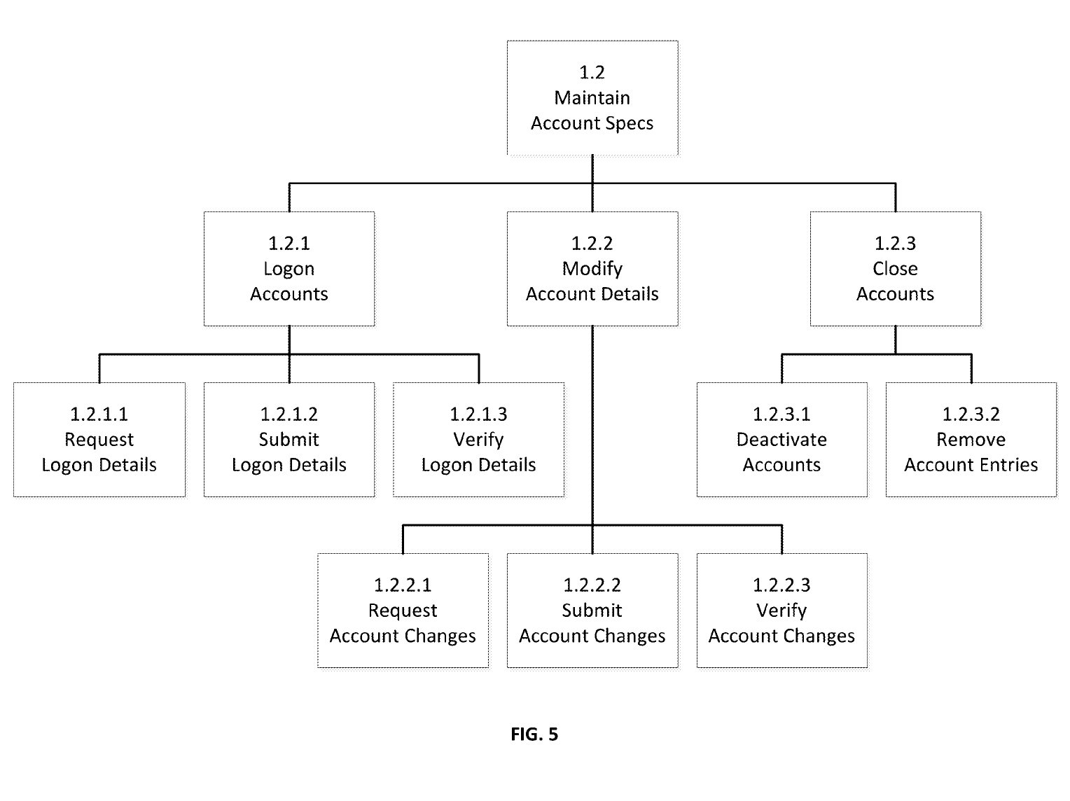

FIG. 5 is a breakdown of the 1.2 “maintenance of account specifications” sub-functionality, which functionality encompasses any operations involving existing account details. For instance, the operation of logging into the system involves the application requesting logon information from a system user, typically in the form of a user name and password, before providing a logon request to the middleware. To verify whether the account information is registered and active, the middleware may preferably be configured to crosscheck the logon information with that of the accounts tabulated in the database. Suitably, the middleware may be configured to deny access to the system whenever an account cannot be located or the account information is incorrect. The middleware may be configured so that multiple failed login attempts may cause the system to lock the account. Alternatively, the middleware may be configured to grant access to the system whenever an account cannot be located or the account information is incorrect, wherein the middleware is further configured to track user activity. In such an instance, the user granted access may suitably be unable to access any of their primary account functions. Instead, the user will be directed immediately to online user support systems which will enable them to recover their forgotten password and/or determine why their primary account functionality is no longer accessible such as it having been deactivated.

Still referring to FIG. 5, the application and middleware are configured to modify existing account details. For this purpose, the application and middleware may be configured as common form-based data entry showing the allowable fields to change and providing a separate editable field to make the change. In some instances, the application requests the change through the middleware and the middleware verifies the changes and notifies the application of errors. Whenever no errors exist in the change request, changes may be forwarded to the database by the middleware.

Yet still referring to FIG. 5, occasions may arise wherein an account may be closed and purged from the database. The system may be configured wherein an account having outstanding obligations cannot be closed (e.g., payment due on a buyer's account). Preferably, such obligations must be completed or cancelled before the middleware can deactivate the account. In general, the account may remain in the system for extended periods of time before the middleware purges the account from the account tables in the database.

Occasions may further arise wherein an account may be deactivated. Suitably, a deactivated account may allow the account holder to access the system to view past orders and search queries. However, deactivated accounts cannot place new orders or use any of the system's other functionalities.

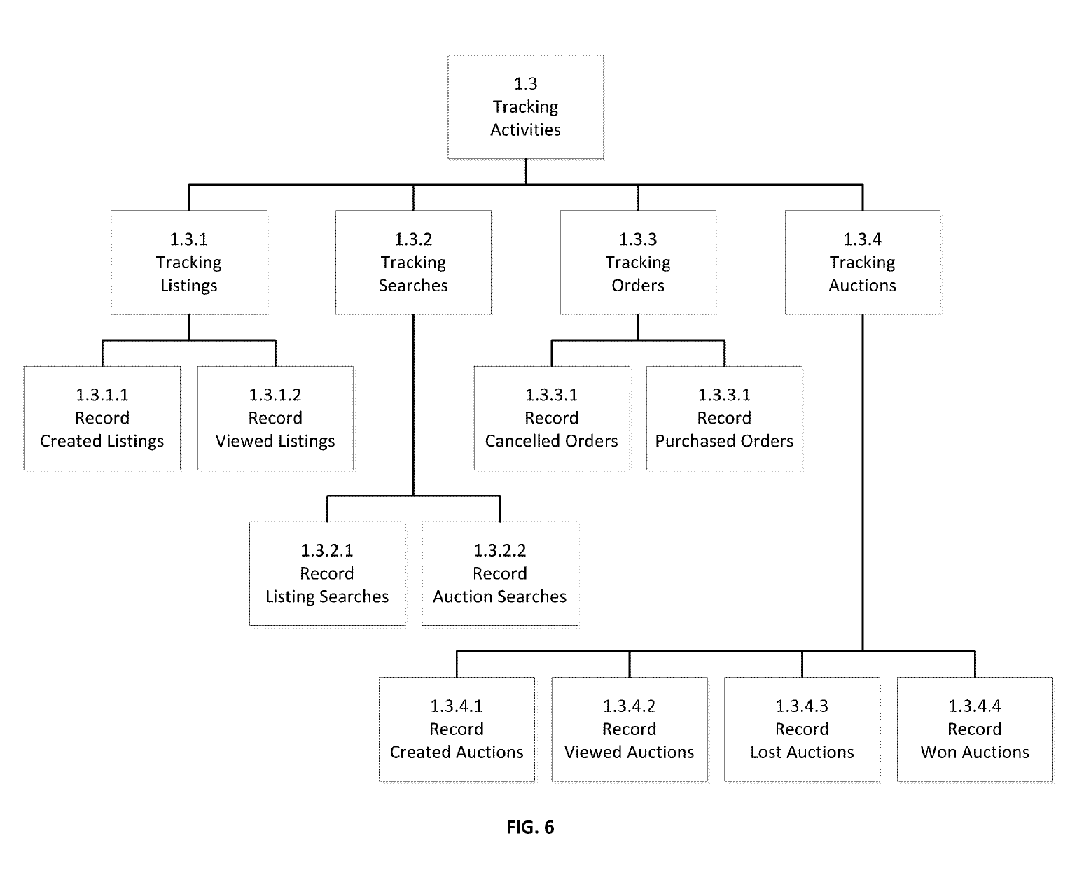

FIG. 6 is a breakdown of the 1.3 “account activity tracking” sub-functionality. This sub-functionality may suitably be configured to tie any changes to the database to an account so that the account responsible for making the change can be identified. In one embodiment, tracking can be accomplished via providing an indication of the activity to the database in the form of a bridge table (a bridge table, also known as a junction table, is a relational database table that contains common fields from two or more tables). Preferably, the system may be configured to track, among other things: the creation or viewing of a commodity listing or purchase order; commodity listing or purchase order search history or trail (including search strings and filter); and, the creation, viewing, and result of a freight delivery service auction. In one embodiment the activity tracking log may be in the form of a history. Such tracking features may further be configured to provide users with a history of their account actions, enabling them to draw informed conclusions from their usage patterns and provide familiarity with the consequences they may generate. In some cases, the system is configured for the cloning of past activities whereby repeatable processes can be accomplished quickly or without being redone independently.

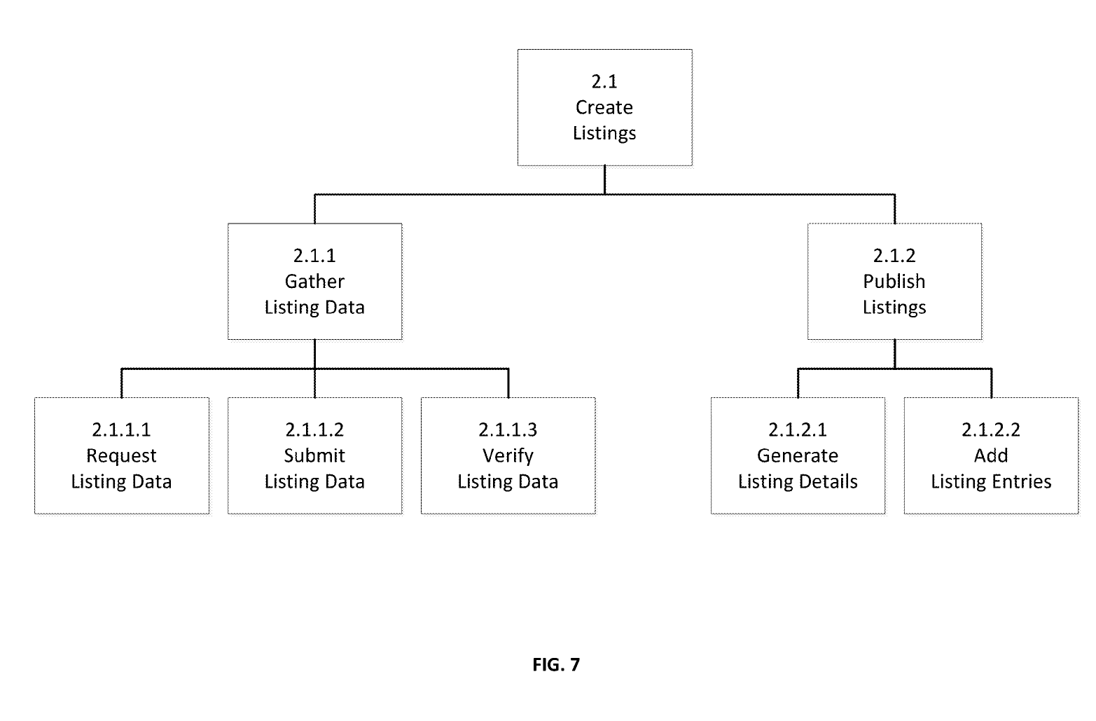

FIG. 7 is a breakdown of the 2.1 “creation of commodity listing” sub-functionality of the 2 “management of inventory” high level functionality. Suitably, the application and the middleware are configured to request data about a commodity, gather the requested data, and populate the database with the gathered data. In one embodiment, the application requests the following: seller name; seller location; listing title; listing price; listing length (availability of the listing); listing quantity; commodity information; commodity photograph; commodity origin; commodity grade; lot size (for freight calculations); lot weight (for freight calculations); payment terms (e.g., acceptable payment methods); any customized comments or descriptions. Suitably, the application and middleware should further be configured with safeguards to prevent incorrect data from being introduced to the database. For instance, the application may be configured to request commodity listing data in the form of questions to determine the focus and the details of the listing. After gathering the data with the application, the data may be submitted to the middleware for verification and quality assurance to ensure the integrity of data populating the database. Once the data is deemed appropriate by the middleware, the middleware may suitably (1) populate the database by generating a commodity listing table containing the commodity listing data in association with the account responsible for the listing and (2) publish the listing so that the published listing is available for searching and viewing by other users operating the application on a front end device.

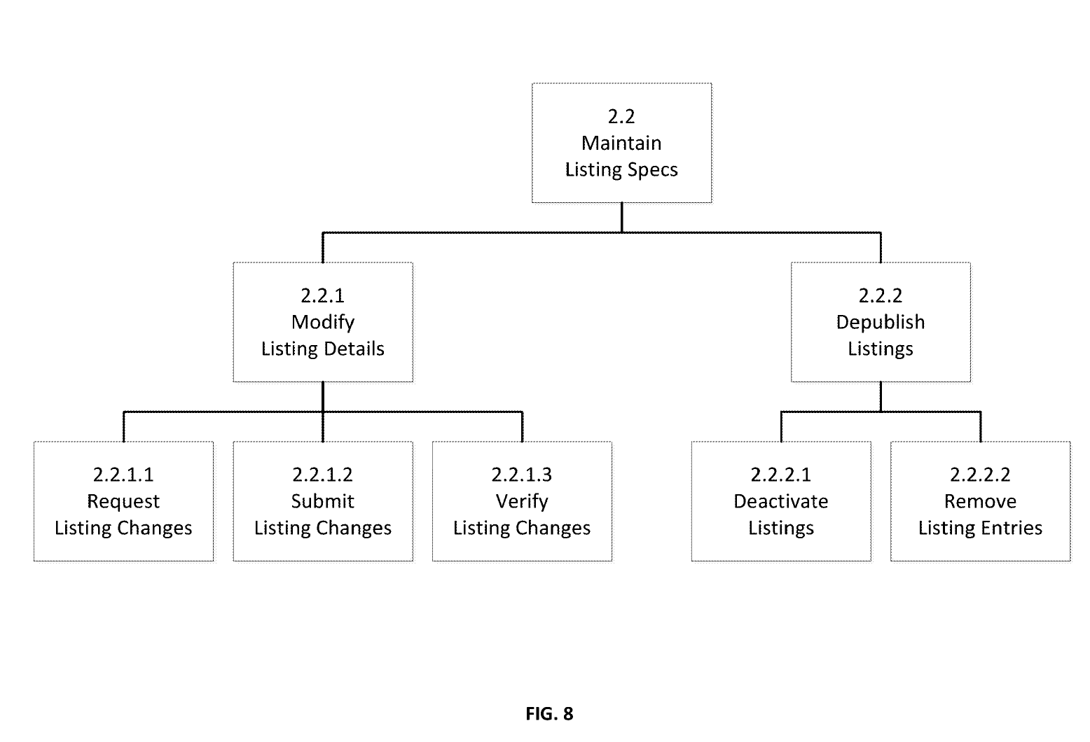

FIG. 8 is a breakdown of the 2.2 “maintenance of listing specifications” sub-functionality of the system. In certain embodiments, the application and middleware are configured to allow editing and modification of commodity listings. Preferably, changing or modifying operations are available on a per listing basis. In some instances, modifying listings which are not associated with the user's account is prohibited. Suitably, when important fields are modified, permission may be required from the system. Suitably, changes to listings may also include safeguards to prevent incorrect data from being introduced to the database. In certain embodiments, the application may guide a user through the editing of a commodity listing via a similar process as used to create the listings (e.g., requesting the data in the form of a question). After the application has submitted commodity listing changes to the middleware, the middleware verifies the changes and determines whether the changes should be reviewed or have immediate effect.

Still referring to FIG. 8, users of the system may desire to depublish a commodity listing. For instance a user may decide to depublish a listing that no longer serves a purpose (e.g. change of seasons, crop shortages). To this end, the middleware may suitably be configured to modify any relevant database entries and to deactivate the associated commodity listing data. Notably, depublished commodity listings may not immediately be purged from the database. Instead, the system may be configured to store commodity listings for a period of time duration after depublication so that the listings remain in the database for either (1) accounting purposes of the user, (2) republication by the user, or (3) edit by the user for a similar commodity listing.

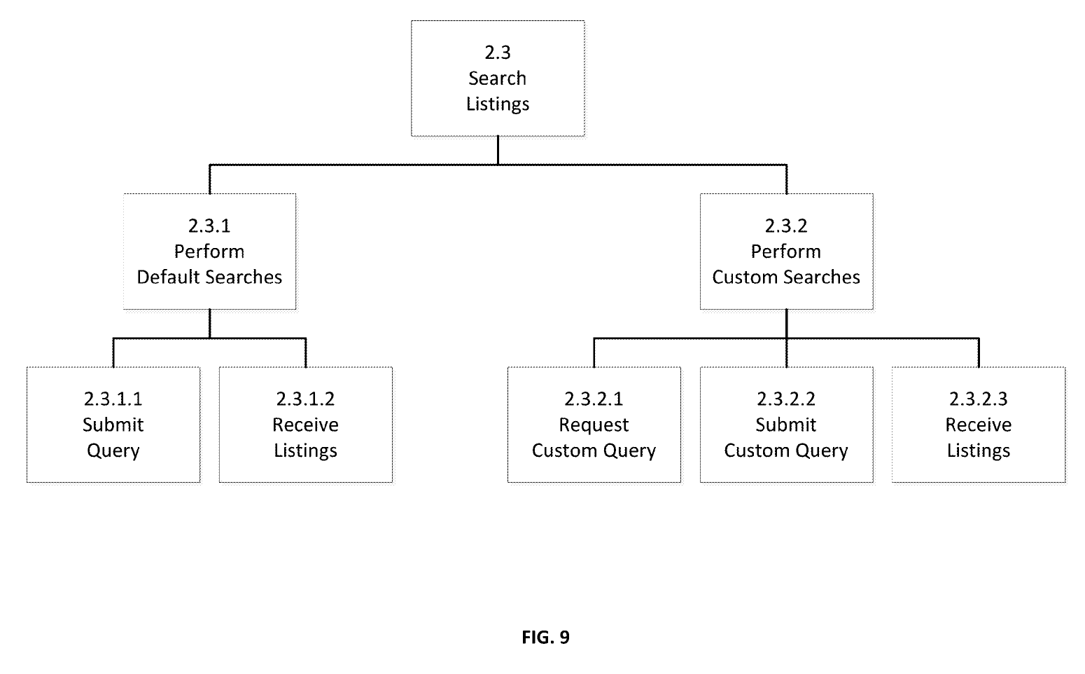

FIG. 9 is a breakdown of the 2.3 “listing search engine” sub-functionality of the system. In most instances the application and middleware are configured with a search engine for searching through the commodity listings within the database. In one embodiment, the search engine is configured with filters whereby users may create custom searches of the commodity listings. For example, the commodity listings may be filtered by: seller name; seller location; listing title; listing price; listing length; listing quantity; commodity information; commodity photograph; commodity origin; commodity grade; lot size; lot weight; payment terms (e.g., acceptable payment methods); any customized comments or descriptions. In operation, a user may submit default or custom queries to the system via the application, wherein the middleware translates them to the database, receives the search results, and then returns the results to the application for formatting and presentation. In a preferable embodiment the search engine is configured to store search preference and histories so that custom searches may be saved for later use without the need to reconfigure filters and search parameters.

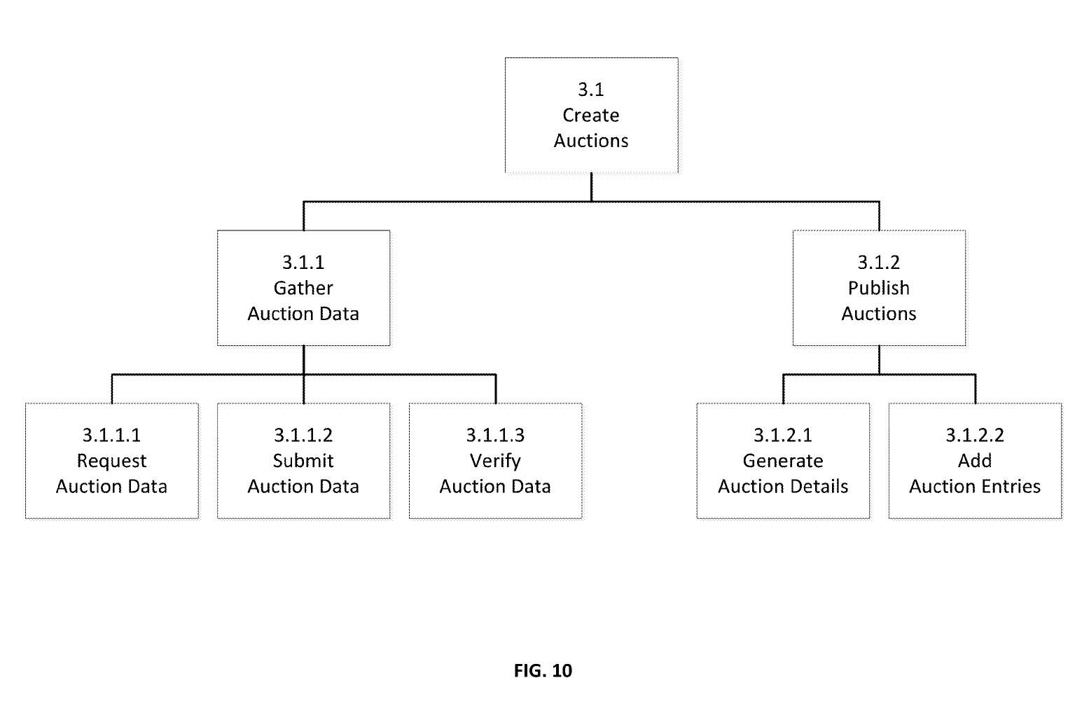

FIG. 10 is a breakdown of the 3.1 “auction creation” sub-functionality of the 3. “management of auctions” high level functionality. As discussed above, carriers may suitably bid to provide freight delivery services to a buyer or seller of a commodity. Thus, it should be noted that users preferably do not use the system to create freight auctions directly. Instead, a freight auction may suitably be created by the middleware whenever seller and buyer accounts agree on the provisions of a commodity order. Suitably, the application and middleware are configured to request data from the users that is necessary to arrange and auction listing (e.g., delivery pickup and drop off locations, shipment weight, and the like). Additionally, the middleware may further be configured to publish freight auction listings. In one embodiment, the middleware publishes the auction listing via first gathering the auction data, populating the database with the data, and providing the auction listings to the user via the application.

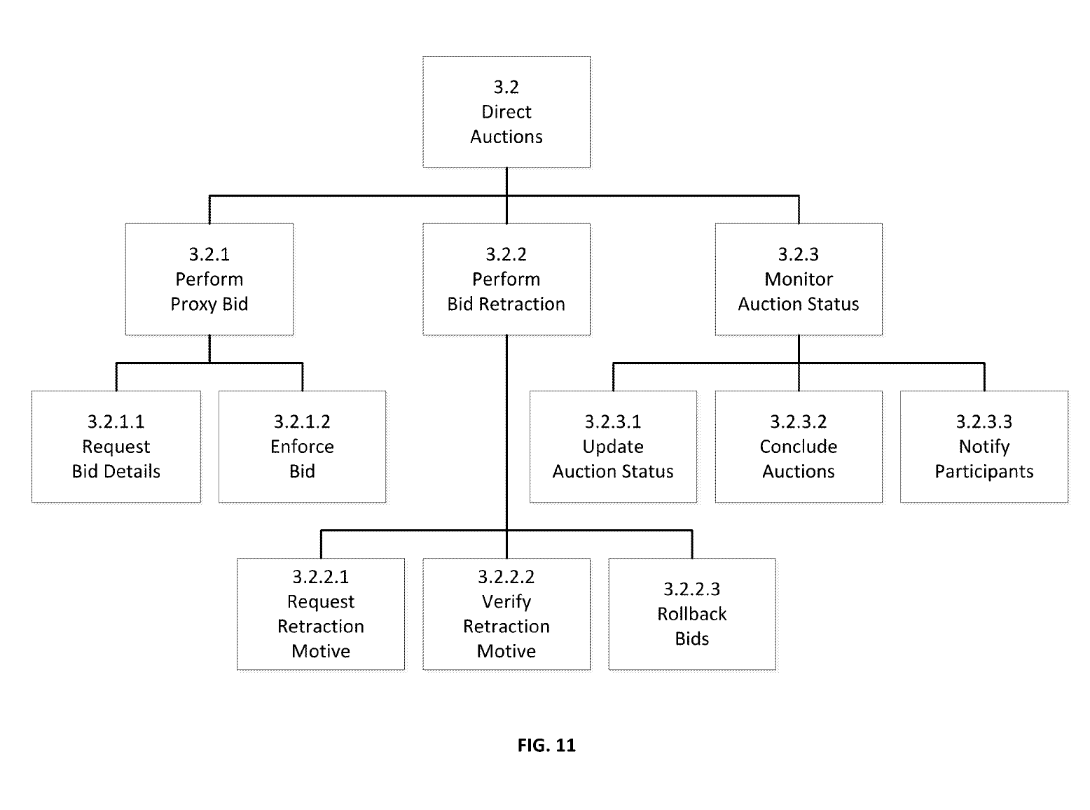

FIG. 11 is a breakdown of the 3.2 “auction direction” sub-functionality of the system. Operably, this sub-functionality provides users with the ability to bid on auction listings. In one embodiment, carrier account users use the system to search through auction listings and make bids to provide freight handling services for the associated buyer and seller. When carrier account users bid on auctions, the middleware requests from them the lowest price for which they are willing to perform freight services. For the first bid, the application and middleware may further be configured to request an initial price upon which every subsequent bid is based. Once the initial price has been provided to the system, the middleware updates the database and enforces the proxy bid auction rules. Suitably, the middleware is configured to perform proxy bids wherein the middleware stores two bids, namely, the lowest bid and the lowest bid plus some decrement amount. In an alternate embodiment, the middleware may store all bids made in order to provide roll-back functionality in the event of multiple bid retractions. In such an alternate embodiment, the proxy bidding system would preferably remain the same.

Referring still to FIG. 11, situations arise wherein bidding carriers may be desirous of retracting a bid that has been submitted to the system (e.g. to correct a typo or in response to a changed auction listing). To accommodate bid retractions, the application and middleware may suitably be configured to receive bid retraction requests, verify legitimate bid retraction motives, and roll-back bids. In one embodiment, the application and middleware may request a reason for the retraction and verify whether the retraction should be allowed to occur. If the retraction is allowed, then the middleware rolls back all bids and determines the highest bidder without taking into account retracted bids and updates the relevant database entries accordingly. In some cases, to prevent bid shielding, “shill” bidding and/or other unethical forms of bidder collusion, bid retractions can be only made with permission from system administrators.

Yet still referring to FIG. 11, auction bids may suitably be constantly monitored. In one instance, the middleware is configured to immediately update the auction status whenever the auction listing or lowest bid changes. The system may preferably also be configured to notify bidders whenever changes to the auctions affect them (e.g., a bid lower than their own bid has been entered). In one embodiment, the system may be further configured to notify bidders of a concluded auction. As discussed above, the winning bidder may, after the conclusion of the auction, be assigned to haul the commodity listing of the underlying purchase order for the concluding bid price.

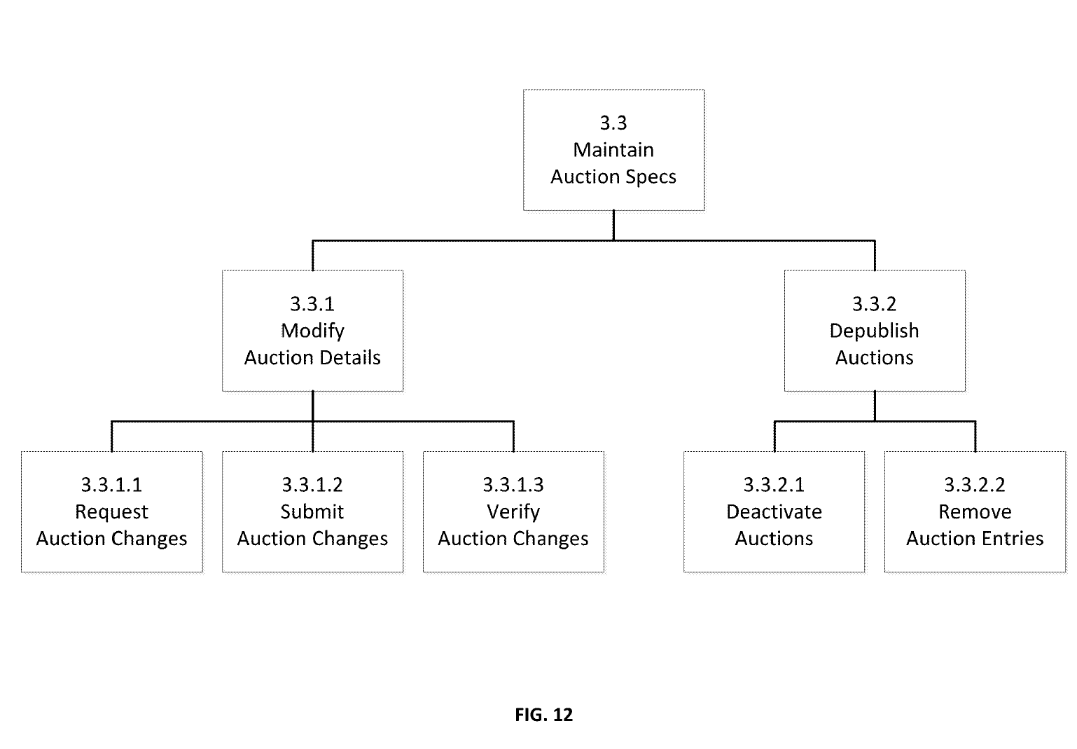

FIG. 12 is a breakdown of the 3.3 “maintenance of auction specifications” sub-functionality of the 3. “management of auctions” high level functionality. To some extent, the 3.3 “maintenance of auction specifications” is similar to the 2.2 “maintenance of listing specifications” sub-functionality. Circumstances may arise wherein system users decide to change the details of auction listings (e.g., whenever a buyer and seller change the pickup or drop locations for freight). In such circumstances, the application and middleware may be configured to request from the users any changes to be made to the auction listing. In one embodiment the application and middleware may additionally be configured to request reasons for the changed listing. Suitably, the middleware may be configured to verify the changes and determine whether the changes should be published or whether the change needs to be reviewed by system administrators prior to publishing the change. Preferably, the middleware may be configured to update the relevant database entries after the changes are validated.

Referring to FIG. 12, system users may further decide to terminate auctions (e.g. order disputes between seller and buyer). Suitably, cancellation of a purchase order which underlies an auction necessarily results in a cancellation of the auction. Therefore, the application and middleware may preferably be configured to depublish any cancelled auctions. The middleware may also be configured to update the database population whenever the statuses of commodity orders have changed. All participants of auctions at the time of cancellation are also notified.

The 3.4 “auction search engine” sub-functionality of the 3. “management of auctions” high level functionality may suitably be operably similar to the 2.3 “listing search engine” sub-functionality.

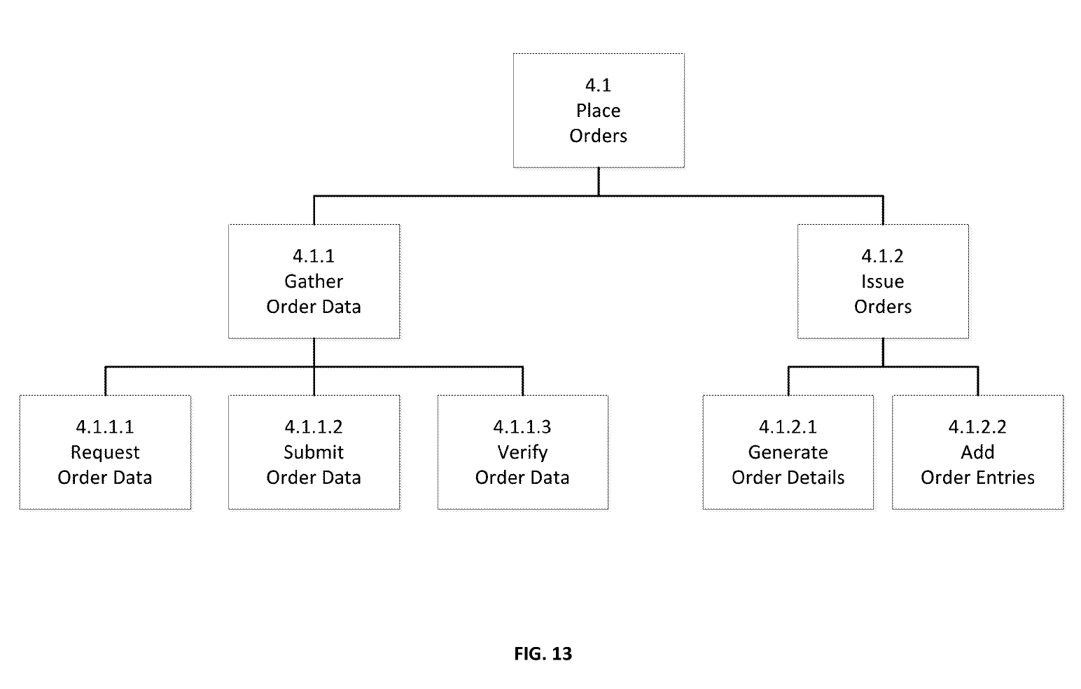

FIG. 13 is a breakdown of the 4.1 “order placement” sub-functionality within the 4. “management of orders” high level functionality. As alluded to above, orders are made by buyer accounts with reference to a particular commodity listing from a seller account. Operably, the application and middleware of the system may be configured to request data to create orders from buyer account users. Suitably, the requested data may be submitted by the application to the middleware, which may preferably be configured to lock out the quantity of commodities being ordered from respective listings. Practically, said lock-out configuration may suitably safeguard against situations wherein multiple buyer accounts place orders which are for the same commodity listing or which exceed an available commodity inventory. In one aspect of the system, the middleware is configured to populate the database with order data in order tables, after said data has been verified. Once the entries are created in the order tables of the database, orders are considered live.

In one embodiment of the system, multiple database servers exist (whether in the same cloud or at geographically separated datacenters). In such an embodiment, a need may exist for synchronization of the database servers. Such synchronization creates the potential for transaction errors based on data drift. Suitably, for purchases made through the system, the system may use transaction locking as a safeguard to data drift across all database servers. Preferably, purchase requests put into the system may be compared to locked data on all the other servers. Typically, whenever purchase requests do not match locked commodity listings, a time-stamped lock may be put on said commodity listings so that it cannot be requested or purchased by any other buyer account. In the event of two buyers attempting to purchase the same commodity listing, the purchase request with the earlier time stamp lock may preferably be awarded the purchase order. The unawarded buyer may preferably be informed by the system of the failed purchase request and also be provided with an update of the remaining amount of the item for sale in question. It should be noted that: if a buyer desires a commodity in an amount that exceeds a particular seller's inventory, then the system may suitably be configured to (i) inform the buyer that an insufficient amount is available from the chosen seller and (ii) present the buyer with a selection of commodity listings which closely match the original order (e.g., in terms of commodity type, size, grade, and distance to the original seller). Such a configuration allows the buyer to have a chance of obtaining the desired quantity of the commodity from another seller or, by drawing upon the amounts available at multiple sellers, purchasing a portion of the desired quantity from multiple sellers.

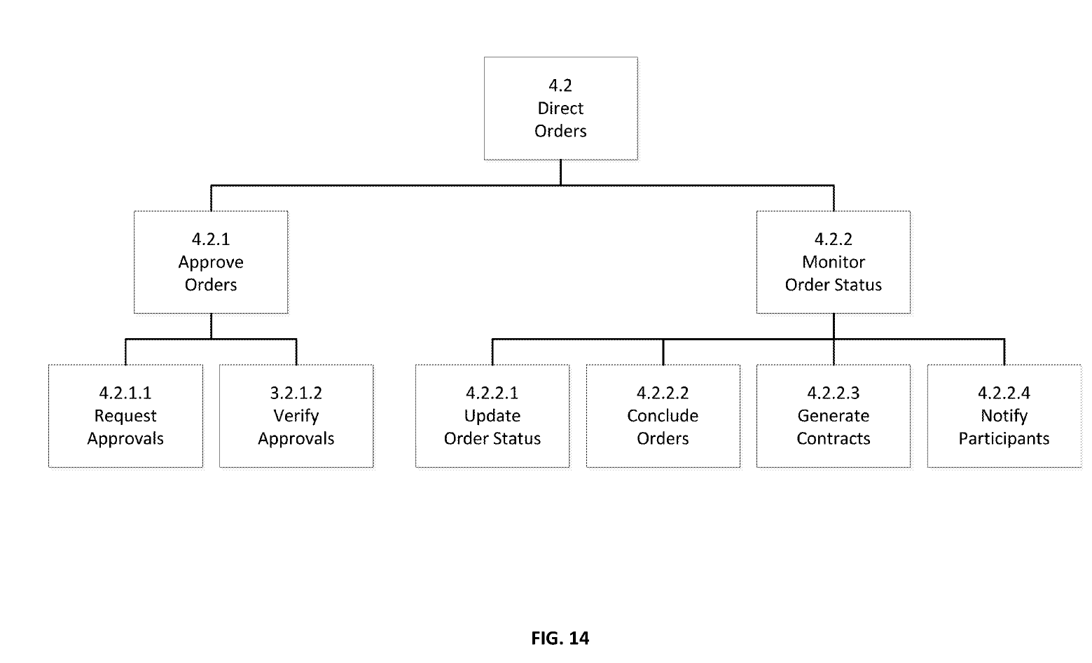

FIG. 14 is a breakdown of the 4.2 “order direction” sub-functionality of the system. As alluded to above, orders have a lifecycle which begins when a commodity listing is selected by a buyer and ends when, after approval of the seller and arrangement of freight handling services, the commodity is delivered to the buyer. As a result, the system may preferably be configured to constantly monitor an order throughout its lifecycle. Suitably, a first phase of monitoring occurs during the approval process of an order, wherein buyers, sellers, and carriers must approve the provisions of the order. In one embodiment, the system is configured to send approval requests to the buyer, seller and carrier accounts, wherein (1) sellers initially approve a buyer's order, (2) carriers must approve freight handling services for the buyer/seller, and (3) then buyers must approve of the commodity order and freight handling services. Operably, whenever either (a) one of the buyers or sellers does not approve, (b) no carrier service is available, neither the buyer nor the seller can provide freight services, and the buyer does not choose to run the order through the carrier bidding system again, the system may suitably be configured to cancel the underlying order. Conversely, whenever all of the buyers, sellers, and carriers approve an order and freight transport services, the middleware may suitably be configured to (a) generate any required contracts and (b) send the contracts to the buyers, sellers and carriers. Buyers, sellers and carriers may, at that point, fulfill the contracts and update the status of the order. The middleware may suitably be configured to notify buyers and sellers of any changes to the orders.

The 4.3 “maintenance of order specifications” sub-functionality is suitably similar to the 3.3 “maintenance of auction specifications” sub-functionality of the 3. “management of auctions” high level functionality and the 2.2 “maintenance of listing specification” sub-functionality of the 2 “management of inventory” high level functionality.

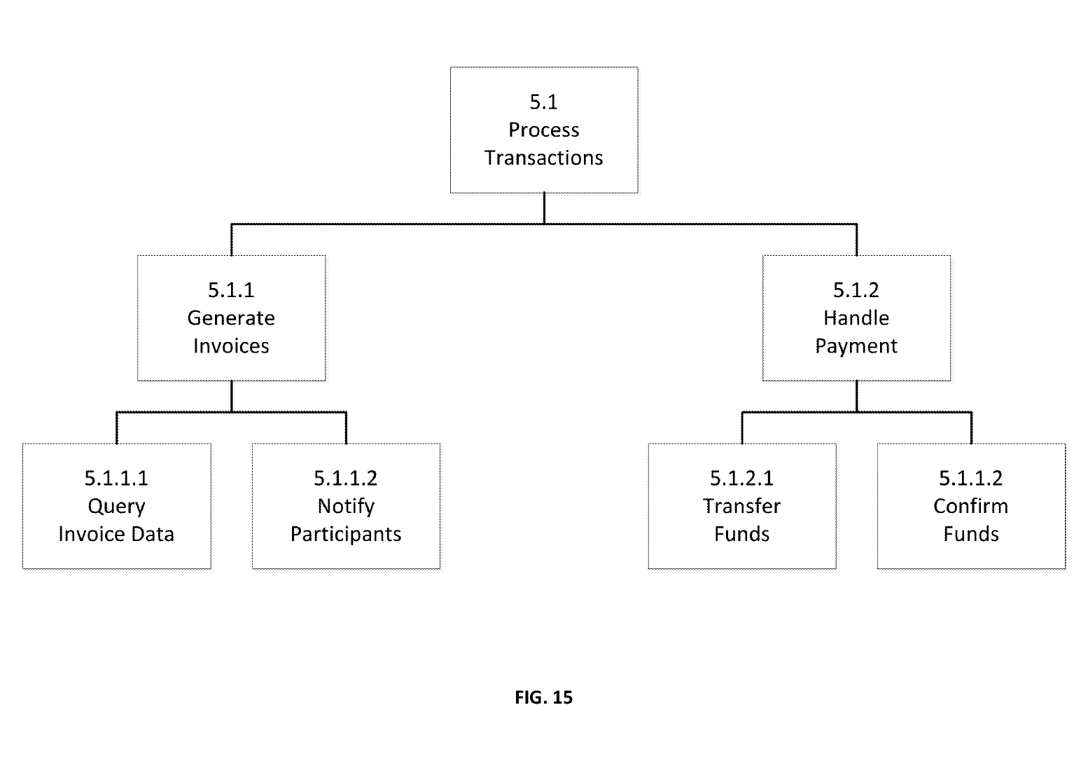

FIG. 15 is a breakdown of the 5.1 “transaction processing” sub-functionality within the 5. “management of payment” high level functionality. When buyers, sellers, and carriers have exchanged the commodity and provided freight services, the system may be updated to reflect that the purchase order has been fulfilled. Upon order fulfillment, the middleware may preferably be configured to query required pricing data from the database and generate invoices for fees pertaining to use of the system (e.g., a broker fee or commission for facilitating the transaction). The middleware may further be configured to deliver the invoices to the various accounts via email, a software application on a front-end device, facsimile, or physical mail. The middleware may yet further be configured to, upon payment of all invoices, change the order status to complete. In some embodiments, payments of invoices can be processed through a variety of online solutions from merchant accounts to credit cards services to direct bank transfers. Such third-party services can be integrated into the system so that it is aware of the state of these transactions.

In addition to the above described high level functionalities and their sub functionalities, it is contemplated that the system may further employ additional extended features. Such features may include: truckload filling meters; live order tracking; historical database reports; standing search price alerts; price protection; relative price index adjustments; and average price determination.

“Truckload filling meter” is an optional feature of the system wherein buyers may track the quantity of commodities they are ordering with respect to a preset truck capacity. Data regarding the commodity size and shipping parameters may be included in the product listing. For instance a commodity listing may include information regarding the number of commodity units comprising a package, the number of packages comprising a pallet, and the number of pallets comprising a truckload. The intent of this feature may be to enable buyers to (a) more exactly specify the precise amount of commodity that is needed to fill a truck to capacity and (b) make the most cost-efficient use of freight services. In other words, this feature may be used to avoid the costs of an additional truck for hauling an order that is slightly oversized.

Live order tracking is an optional feature of the system which requires a separate application designed specifically for carriers which tracks the status of an order through each stage of the delivery process (e.g., from the point the carrier is selected to provide freight transport services to the point where verification is received from the buyer that delivery of the commodity has been received). Suitably, the tracking application begins whenever the carrier arrives at the pickup location. Initially, a seller inspects the commodities to be delivered before the commodities are loaded onto the carrier's truck. Based on the results of the inspection, the application is used to update the order with the exact amount loaded. Upon departure of the truck from the pickup location, the seller or carrier may use the application to update the order to an in transit status. Throughout transit, GPS hardware coupled to the application may be used to keep track the truck's location en route to the drop-off destination. In one embodiment, the GPS hardware is on the truck-driver's cell phone. Preferably, buyers, sellers, and carriers can all track the shipment location. In one embodiment, whenever the systems detect anomalies (e.g., deviation of the truck from a predetermined truck route, a prolonged stop by the truck driver, etc.) buyers, sellers and carriers are notified and the order is updated to reflect its current status. In some embodiments, the system may post a request to the driver to explain the delay in transport. The application may be configured to update the shipment whenever it is close to its destination, whenever the shipment arrives at its destination, and/or whenever the shipment is unloaded and verified by the buyer.

Historical database reports may be a feature of the system. Using historical commodity listings and auction results, it is contemplated that, over time, enough data will have been accumulated to generate accurate reports to help project market prices, seasonal sales, quarterly statements and etcetera for various commodities.

Standing search price alerts may be an optional feature of the system which allows users to queue active price-based searches into the system. Suitably, the system will periodically execute queued searches against the database population in the manner discussed above. Preferably, the searches may be made active or inactive. Optionally, a standard search may be converted to a standing search whenever the system receives no matches to the standard search query. To with, the user may be provided with the option to turn the standard search into a standing search, wherein the user will receive a notification can be sent when a match to the search query is found.

In some embodiments of the system, sellers may offer price protection on all purchase orders. That is to say: whenever the market price of a listed commodity is reduced by the seller while a purchased quantity of the same commodity is in transit from the seller to the buyer, the buyer account for the order is entitled to the pay the seller account the lower market price (e.g., after a purchase order is made by a buyer, but prior to delivery of the ordered commodity, if the seller changes the pricing for a similar commodity to the ordered goods, then the buyer is guaranteed by the seller that the price upon delivery of the commodity may suitably be lowered to match the seller's new price). Preferably, price protection may be available as long as the commodity has not yet been delivered to the buyer. In one embodiment, the system is configured to determine whether a delivery remains in-transit and notifies the buyers and sellers of the pricing changes. In a preferable embodiment, the price protection functionality of the system only applies to downward changes in cost (i.e., increased pricing for a seller's commodity may not be applied to in-transit commodities). Preferably, the system may be configured to automatically adjust the price of in-transit goods whenever price protection is applicable. Suitably, price protection functionalities of the system do not apply to pricing changes of a commodity after delivery of a commodity is complete and shipment has been accepted by a buyer.

In other embodiments of the system, functionalities may be provided to the application software and middleware whereby a Seller account may optionally set a “relative price” for a commodity listing. The “relative price” applied to the commodity listing is an automatically adjusting price that is set relative to the average price of recently-completed transactions through the system for the underlying commodity. For example, 100 recent purchase orders of a particular size and grade of onion units in the West Coast Region have an average price of $10 per unit. In such a circumstance, commodity listings for onion units may be set, e.g., at either a fixed price per unit, such as $10, or a relative price of 95% (percent) of the average selling price per unit. In one instance, if the average market price for the onion units spikes to $20, the relative price of the commodity listing that was set to 95% (percent) of the average price will automatically and profitably be raised to $19.00 per unit, while the fixed price commodity listing will remain unprofitable at $10 per unit until and unless it is manually updated by the seller—but in the interim, the entire listing's quantity may be bought out rapidly at its initial price, resulting in the seller losing profits and being unable to properly take advantage of the climbing market price of the commodity. Similarly, if the market price crashes to $5 per unit, the relative price commodity listing may suitably be automatically lowered so that the listing price is competitive with the market at $4.75 per unit, whereas the fixed price commodity unit will be too high in price at $10 per unit to be competitive with the market. Preferably, “ceilings” and “floors” may be employed to restrict the price of the commodity to prices which are not too low or too high.

Many potential users of the disclosed system may already have established, enterprise-based, third-party supply-chain software solutions which are integral to their business processes. For instance, a majority of accounting and bookkeeping functionalities are performed and cataloged entirely through these third-party software solutions. Such software solutions are, in some instances, so heavily entrenched in all aspects of the user's supply-chain that it would be unsatisfactory for the disclosed system to be incompatible with such already in-use software solutions.

Electronic Data Interchange (EDI) is a third party software solution that may be incorporated by the disclosed system. EDI enables the automated electronic transfer of documents or business data from one computer system to another computer system. Third-party EDI accounting services enable users to connect their systems, exchange data, and transact electronically while keeping their accounting up to date. As alluded to above, the system may generate certain documents during its various operations. Such documents may be EDI compliant and include: Purchase Orders; Confirmation of Sales; Bill of Ladings; Seller Passings; and, Invoices. In a preferable embodiment of the system, buyer and seller accounts may utilize EDI to interchange data between the buyer and seller front end devices of the system and accounting software used by the buyer and seller (e.g., Quickbooks, Produce Pro, etc.) to generate invoices, purchase orders and the like.

As alluded to above, the disclosed system may preferably operate over a series of servers which are connecting to front end devices over the internet. As a result, security measures may suitably be employed to prevent unwarranted access to the system. Said unwarranted access renders the system subject to viruses or other malware which can prevent system functionalities from operating as intended. Viruses and malware can also destroy data which is integral to users' businesses. In one embodiment, the system employs a server firewall as a security measure, wherein the firewall performs stateful packet inspections, network honeypots, and other intrusion countermeasures.

In addition to the firewall, each virtual server within the cloud may suitably be fully port restricted to only those ports necessary for executing the above described functionalities. Database servers will, in addition to being port-restricted, be Internet Protocol (IP) Address-locked. As such, the database servers may preferably only accept encrypted queries and synchronizations from the IP addresses of known application and database servers on the internal virtual networks contained within each cloud instance.

In one embodiment, front end devices connect users to the system. Connections to the system via mobile software or internet-based applications may suitably be encrypted using 256-bit, 512-bit, 1024-bit, 2048-bit, or greater Secure Socket Layer (SSL) encryption. Repeated login failures from an internet-based or mobile software application will result in the IP address being blocked for an hour and the user notified via email, SMS text message, or similar means. Operably, while a user's IP address is blocked, further attempts to log in from that IP address may suitably be refused, and an error message may suitably be displayed indicating that the maximum number of login attempts has been exceeded. For temporary blocks, the message may preferably further communicate the duration of the block. In another embodiment, successive login failures after a block is lifted on an account may preferably result in the originating IP address being permanently blocked from the system and the user being directed to customer support services for verification of their identity and assistance with recovering their login information or having the block removed.

Another form of security measure employed by the system suitably safeguards against SQL injection. SQL injection is a form of malware used to obfuscate a system's data by convincing an application to execute code that was not intended. In one embodiment of the system, the middleware may preferably be the only program code configured to construct SQL queries to the databases of the system. This means that applications on front end devices should preferably not be provided with functionalities for submitting SQL queries directly to the database. In the system, SQL injection may further be minimized due to network segregation, IP Address-locking, port restriction, and other security precautions for the SQL database disclosed in the preceding paragraphs.

D. The Middleware

As discussed above, many of the functionalities of the system are operated by the middleware. More specifically, the operations of the middleware are provided through a series of interfaces, namely:

<<interface>>

### ListingServices

+create( )
+modify( )
+activate( )
+deactivate( )
+search( )
+watch( )
<<interface>>

### AccountServices

+create( )
+activate( )
+deactivate( )
+logon( )
<<interface>>

### OrderServices

+create( )
+cancel( )
+accept( )
+decline( )
+modify( )
+updatestatus( )

### +Search( )

<<interface>>

### AuctionServices

+create( )
+activate( )
+deactivate( )
+modify( )
+placebid( )
+search( )
+watch( )
<<interface>>

### PaymentServices

+payusingcreditcard( )
+payusingdirecttransfer( )
+payusingpayservice( )
<<interface>>

### MessagingServices

+send( )
+sendemail( )
+sendfax( )
+receive( )
<<interface>>

### ReportServices

+generatemarketprice( )
+gemeratesales( )
<<interface>>

### DocumentServices

+generateinvoice( )
+generatecontractsofsale( )
+generatecontractofcarriage( )
+generatebrokerconfirmation( )
These interfaces represent the interface of the application and the middleware. Program code such as the middleware is sometimes referred to as a producer since the middleware is performing the operations and functionalities of the system without compromising security. Program code such as the application is sometimes referred to as a consumer (e.g. cell phone application, internet-based application, etc.) since the middleware is expected to perform the operations of the system while the application merely provides inputs and outputs of data. The application only needs to be aware of the interface and does not usually require a configuration for the implementation details of the system operations and functionalities. The middleware is only concerned about the implementation details of the operations and functionalities outlined by the interface.

E. The Database Model

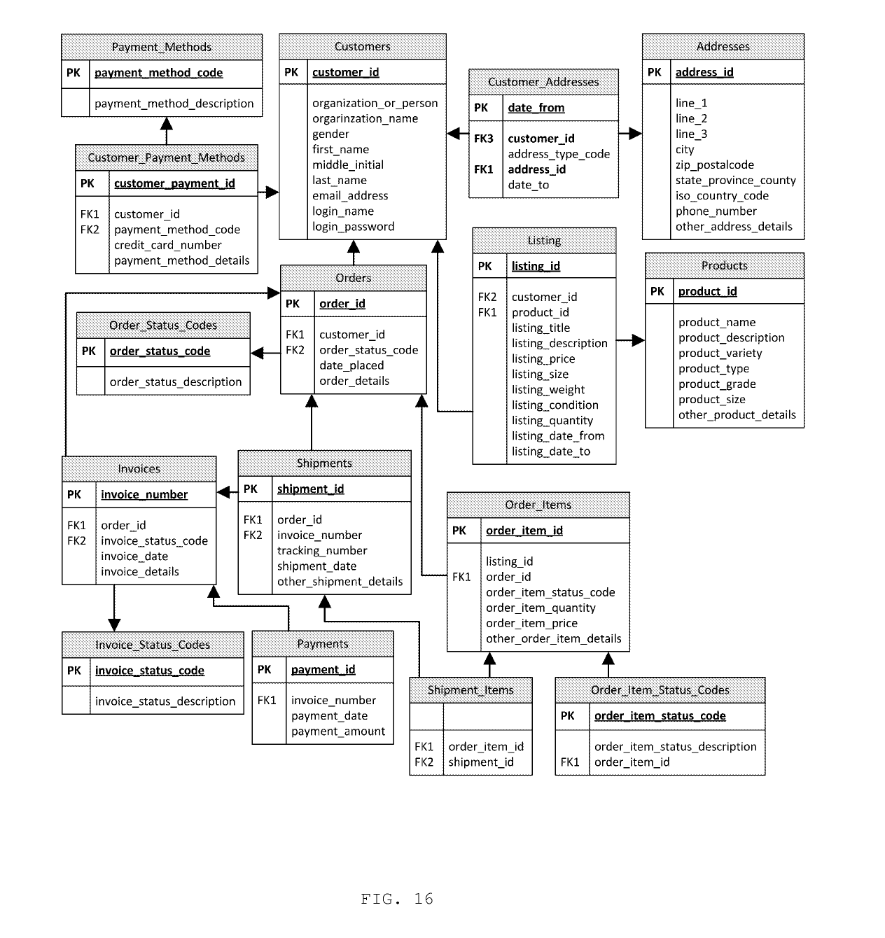

FIG. 16 is a database model which represents a preferable database management structure for the disclosed system. The implementation of the middleware operations and functionalities may suitably directly access data within the database through the use of SQL queries. Depending on the enterprise technology (e.g. .NET ODBC or Java JDBC), these queries may suitably be routed to the underlying relational database management system where they are processed. Database objects are used to represent tables in the database as instantiated entities instead of raw data. This approach provides many notable advantages including avoiding embedded SQL, automatic connection handling, database independence and object orientation.

F. System Usage

Buyers are expected to fall into one of several categories; Distributors, who buy commodities in bulk and resell smaller quantities to smaller buyers; Purchasing Agents for large chain restaurants; Canneries; Food Processors for franchises; Retail Chain Store Produce Managers; and, the like. Frequently, buyers desire to purchase large amounts of commodities (e.g., one or more truckloads at a time) and will tend to utilize the following operations and functionalities of the system: Searches (Range, Price, Label, etc); Truckload Filling Meter; Multiple Drop Point Routing; Constant Search and Price Alerts; Standing Buy Order System; Short Order Proxy Bidding System; and Live Order Tracking System.

Notably, buyers may benefit from use of the system. First, the system operates on a 24-hour cycle, which enables buyers to place nationwide orders and address shortages or unexpected needs at any hour of the day or night. Second, buyers are able to complete large transactions with multiple delivery destinations much more quickly and efficiently than via traditional methods. Third, the system enables buyers to track en-route shipments via GPS or alternatively receive status updates regarding the shipments via fax, email, text, or other messaging mechanism. Fourth, buyers may be able to participate in a customer loyalty program to receive bonus points for each truckload purchase through the system, wherein the bonus points can be used to purchase goods via catalog. Fifth, buyers can have standing searches in the system and can elect to be immediately alerted via text, e-mail and/or fax when a commodity which they are in need of becomes available. Sixth, buyers can create long-term Contracts with sellers and carriers, in which product is specifically grown for their needs, and they are guaranteed delivery of a certain amount of product at fixed prices for a certain length of time. Finally, buyers can place and queue Ad Orders, which enable them to agree to a set price for a given Seller's product well in advance of the ship date, so it can be listed in advertisement flyers.

Sellers of fresh produce or other perishable commodities are most often a grower or producer of perishable commodities. Sellers can also be buyers since, occasionally, sellers may overcommit inventory to multiple buyers. In such an instance, the overcommitted sellers may become buyers, and purchase sufficient product from other sellers of those commodities to fulfill their contractual commitments. Suitably, Sellers may utilize the system to move all of their inventories of commodities through the service in a more rapid and cost-effective way than through their internal sales teams, other brokers or distributors. As a result they will be able to make more money, more rapidly, by using the system than they would through traditional methods. Sellers will tend to utilize the following operations and functionalities of the system: Product Listings; Searches (Range, Price, Label, etc); Truckload Filling Meter; Multiple Drop Point Routing; Constant Search and Price Alerts; Standing Buy Order System; Short Order Proxy Bidding System; and, Live Order Tracking System.

Sellers may benefit from use of the system. First, the 24-hour cycle of operation of the system enables sellers to convert crops into cash continually and more rapidly. Second, the system provides sellers with the ability to quickly sell out-of-season items as well as items that are currently in short supply. Third, sellers are more likely to receive the highest market price for rare items—real market value—through the system's proxy bidding-based auction system. Fourth, sellers may utilize the system to track the location of their commodities from pickup, through delivery, all the way to final acceptance by a buyer. Fifth, sellers may use the system to receive instant updates of market price changes, which updates enable them to re-price their commodities and thereby ensure continued sales. Sixth, the system preferably permits sellers to also be buyers so that they may make purchases from other Sellers to fulfill contractual commitments. Seventh, the system enables sellers to perform constant searches of commodity listings to find the high, low, and average price of any commodity, based on a radius from any chosen location. Eighth, sellers may use the system to reach vast numbers of buyers in a manner that cannot be achieved via traditional methods (e.g., telephone). Ninth, sellers may utilize the system to reduce the size of their sales staffs and, thereby, become more profitable. Tenth, sellers may have the selling price of their commodities automatically adjusted by the system to constantly offer their commodities at competitive prices regardless of market price fluctuations. Finally, sellers may elect to receive price alerts from the system via text message, e-mail and/or fax so that they may be updated with the average price on any commodity and modify their prices accordingly.

Carriers provide freight transport services. Notably, carriers only make money while their trucks are hauling. The system enables carriers to keep their trucks more active while avoiding “deadhead” (empty) trips to and from far-away pickup and delivery points via aiding carriers to sort by, bid, win and schedule successive haul orders with the minimum amount of distance between the ending delivery point of one and the beginning pickup point of the next. The system further aids carriers in providing freight transport services by providing advance loading directions for any particular shipment. Carriers may be able to use the following features of the disclosed system: Haul Order Offer and Acceptance System; Special Price Bidding System; Orders Pending Assignment Queue; Closest-Available-Truck Assignment System; Driver Task Queuing System; Driver Task Transfer System; Driver Location Tracking System; Pickup, En Route, Arrival and Unload Confirmation System; Driver Problem Reports (Flat, Accident, Unloading Delays, etc); Driver Scorecard Metrics System; Automatic 1-Hour No-Motion Alerts; Automatic Route Deviation Alerts; Route Alteration and Updating System; Closest-Truck Search and Redirect System; Load Expense Calculator (Fuel, Driver, Problems, etc); Route Map to Destination; and, Fuel and Mileage Logs.

Brokers can use the system to help them better service the needs of smaller Buyers and Sellers that are not large enough to make effective use of the system themselves. It is expected that Brokers will be making extensive use of: Searches (Range, Price, Label, etc); Proxy Bidding System; Truckload Filling Meter; Multiple Drop Point Routing; Constant Search and Price Alerts; and, Live Order Tracking System.

It should be noted that, although the above systems and related methods have been disclosed in connection with perishable commodities, the principles of this disclosure may also be applied to commodities other than perishable agricultural products. For instance, the system could be applied to, without limitation, Fresh and Frozen Meat, Seafood, Poultry, Dairy Products, Produce, Herbs, Spices, Nuts and other comestibles. Furthermore, those of skill in the relevant art will appreciate various other modifications of the system and related methods after reading this specification.

What is claimed is:

1. A computer system comprising:
a first front end device featuring computer hardware and computer readable memory with a first application software;
a second front end device featuring computer hardware and computer readable memory with a second application software;
at least one server featuring computer hardware and computer readable memory with middleware and configured for communication with said front and device(s) and at least one database server featuring computer readable memory; and,
wherein said first application software and said middleware are configured to populate the database with commodity listings which are input into the front end device via a first user;
wherein said second application software and said middleware are configured to provide a search engine for said commodity listings whereby a second user may select a commodity listing based on a search query provided to the second front end device; and,
wherein said first application software, said second application software, and said middleware are configured to arrange a purchase order of the commodity listing by the second user.

2. The computer system of claim 1 further comprising:
a third front end device featuring computer hardware and computer readable, memory with a third application software;
wherein said middleware is configured to populate the database with a plurality of purchase orders in association with a location of the second user, a location of the first user, and the commodity listing;
wherein said third application software and said middleware are configured to provide a search engine for said purchase orders whereby a third user may obtain information regarding a purchase order based on a search query provided to the third front end device; and,
wherein said third application software and said middleware are configured to provide auction services wherein the third user may bid to provide freight services for transportation of a quantity of commodity provided in the commodity listing between the location of the first user and the location of the second user.

3. The computer system of claim 1 wherein said information regarding a purchase order includes information selected from the group consisting essentially of freight size, freight weight, or number of pallets.

4. The computer system of claim 2 wherein:
the first, second and third application software and said middleware are configured for tracking the location of a commodity associated with the commodity listing between the location of the first user and the location of the second user.

5. The computer system of claim 4 wherein said middleware and first second and third application software are configured to present the location of the commodity to the first second and third users on the front end device.

6. The computer system of claim 1 wherein:
the commodity listing and purchase order includes a first price of the commodity; and,
the first application software and middleware are configured to allow the first price to be adjusted to a second price by the first user.

7. The computer system of claim 6 wherein the middleware is configured to adjust the first price in the purchase order to the second price whenever the first price is higher than the second price.

8. A computer system comprising:
at least one server featuring computer hardware and computer readable memory with middleware and configured for communication with a plurality of front end devices and at least one database server featuring computer readable memory; and,
wherein said database server is populated with a plurality of commodity listings;
a first front end device featuring computer hardware and computer readable memory with a first application software;
a second front end device featuring computer hardware and computer readable memory with a second application software;
wherein said first application software and said middleware are configured to populate the database with at least one commodity listing which are input into the front end device via a first user;
wherein said second application software and said middleware are configured to provide a search engine for said commodity listings whereby a second user may select a commodity listing based on a search query provided to the second front end device; and,
wherein said first application software, said second application software, and said middleware are configured to arrange a purchase order of the commodity listing by the second user.

9. The computer system of claim 8 wherein:
the commodity listings are respectively associated with prices of a commodity; and,
the middleware is configured to compute the average price of the commodity as reflected in the purchase orders.

10. The computer system of claim 9 wherein:
the commodity listing of the first user and the purchase order include a first price of the commodity; and,
the first application software and middleware are configured to automatically adjust the first price relative to the changing average price of the commodity.

11. The computer system of claim 10 wherein the middleware is configured to not adjust the first price in the purchase order below a minimum value.

12. The computer system of claim 1 further comprising:
a third front end device featuring computer hardware and computer readable memory with said first application software;
wherein the second user may use the search engine to select commodity listings of the first and second user based on a search query provided to the second front end device; and,
wherein said first application software, said second application software, and said middleware are configured to arrange a purchase order of the commodity listings of the first and second user by the second user.

13. The computer system of claim 12 wherein the commodity listings include the size of a commodity and the middleware and front end device are configured to calculate whether the arranged purchase order fills the cargo hold of a delivery vehicle.

14. The computer system of claim 1 wherein the commodity listing is for a rare commodity.

15. The computer system of claim 1 wherein the commodity listing is for an out-of-season commodity.

16. The computer system of claim 8 wherein:
the commodity listings respectively include information regarding the price of a commodity; and,
the first application software and middleware are configured to provide to the first and second users with information selected from the group consisting essentially of the highest price for the commodity, the lowest price for the commodity, and the average price for the commodity.

17. The system of claim 4 wherein the middleware is further configured to notify the third user when the location of the commodity is proximate to the location of the second user.

18. The system of claim 4 wherein the middleware is further configured to notify the second user when the location of the commodity is proximate to the location of the second user.

19. The system of claim 10 wherein the first price of the commodity is automatically adjusted whenever the first user changes the price during transport of the commodity.

20. The computer system of claim 1 further comprising:
a third front end device featuring computer hardware and computer readable memory with a third application software;
wherein said middleware is configured to populate the database with a plurality of purchase orders in association with a location of the second user, a location of the first user, and the commodity listing;
wherein said third application software and said middleware are configured to provide a search engine for said purchase orders whereby a third user may obtain information regarding a purchase order based on a search query provided to the third front end device; and,
wherein said first application software, said third application software, and said middleware are configured to arrange a contract for delivery of a commodity that is associated with the purchase order.

21. The computer system of claim 19 wherein the contract is for delivery of the commodity at a later date.

22. A method of ordering a commodity comprising the steps of:
using a front end device, wherein said front end device features computer hardware coupled to computer readable memory containing application software configured for communication with a middleware on a computer readable memory of a server that is coupled to a database of commodity listings respectively associated with commodities and delivery locations, to identify commodity listings which are associated with a delivery location that are proximate to a location selected by the buyer; and,
using the front end device, wherein said application software and middleware are configured to arrange purchase orders of said commodities, and to arrange a purchase order of a commodity associated with one of said commodity listings which are associated with a delivery location that are proximate to a location selected by the buyer.

23. The computer system of claim 1 wherein the first and second application software and the middleware are configured to arrange an independent review of a commodity associated with the purchase order at the requests of the first or second user respectively made on the first or second front end devices.

24. The computer system of claim 1 wherein the first and second application software and the middleware are configured to arrange the packaging and labeling of a commodity associated with a purchase order by the first user using packaging materials to be provided to the first user by the second user, arranged through the first and second front end devices.
